(19) United States
(12) Patent Application Publication
(10) Pub. No.: US 2026/0029515 A1
(43) Pub. Date: Jan. 29, 2026

(54) EMITTER, LIDAR, AND DETECTION METHOD

(71) Applicant: HESAI TECHNOLOGY CO., LTD., Shanghai (CN)

(72) Inventors: Feng LIANG, Shanghai (CN); Shaoqing XIANG, Shanghai (CN)

(73) Assignee: HESAI TECHNOLOGY CO., LTD., Shanghai (CN)

(21) Appl. No.: 19/344,273

(22) Filed: Sep. 29, 2025

Related U.S. Application Data
(63) Continuation of application No. PCT/CN2024/085386, filed on Apr. 1, 2024.

(30) Foreign Application Priority Data
Mar. 30, 2023 (CN) 202310333074.6
Mar. 30, 2023 (CN) 202310335529.8

(51) Int. Cl. G01S 7/481; G01S 7/487; G01S 17/89

(52) U.S. Cl. CPC G01S 7/4815; G01S 7/4873; G01S 17/89; G01S 7/4876

(57) ABSTRACT

An emitter includes a substrate and multiple lasers. The multiple lasers are arranged on the substrate in an array and configured to emit detection beams. At least a laser of the plurality of lasers is configured to emit a detection beam through a flat light emitting region. A size of the flat light emitting region in a first direction is greater than a size in a second direction.

### CROSS-REFERENCE TO RELATED APPLICATION

This application claims priority to Chinese Patent Application CN202310333074.6, filed on Mar. 30, 2023, and Chinese Patent Application CN202310335529.8, filed on Mar. 30, 2023, the content of both of which is incorporated herein by reference in their entirety.

### TECHNICAL FIELD

This disclosure typically relates to the technical field of LiDAR, and particularly to an emitter, a LiDAR, and a detection method.

### BACKGROUND

LiDAR is a radar system that detects position, velocity, and other features of an object by emitting laser beams, which is a core sensor in an autonomous driving system. The farthest detection distance of a LiDAR on the ground is one of key performance indicators. Factors that restrict the farthest detection distance of the LiDAR on the ground are mainly in two aspects. On one hand, the laser beam illuminates to the ground with a large angle. Based on the principle of diffuse reflection, the ground equivalent reflectivity n_{eff} is very low (n_{eff}=n*cosθ, where n is the reflectivity of the ground, and θ is the incidence angle, namely, an included angle between the incident beam and the normal to the ground). The returned laser energy sharply decreases with the increasing of distance and incidence angle, which limits the farthest detection distance of the LiDAR on the ground (e.g., as shown in FIG. 1, the farther the distance, the greater the incident angle [in the figure, θ_{f}>θₙ], and the lower the equivalent reflectivity; and the returned laser energy is inversely proportional to the square of the distance and directly proportional to the equivalent reflectivity). However, this is a physical rule that cannot be changed.

On the other hand, most LiDARs filter echo signals by using a preset amplitude threshold. For example, when a peak of the echo signal is higher than the amplitude threshold, the echo signal is identified as a valid signal; or otherwise, the echo signal is identified as noise. The amplitude threshold is typically set relatively high to ensure that the signal-to-noise ratio of the LiDAR remains at a high level. For example, as shown in FIG. 2, a spot of a laser beam emitted by a LiDAR has an initial size and a divergence angle, while the farther the laser beam is projected, the larger the spot formed by the laser beam becomes. In addition, when the laser beam is obliquely incident to the distant ground, the spot is elongated (especially, the longitudinal size of the spot is elongated), so the echo returns to the LiDAR at a different time, making the superimposed echo signals become “short and fat” (the echo signal is significantly broadened) with a low peak value. It thus lowers the over-threshold probability of the echo signal, and reduces the detection capability of the LiDAR to the ground (most LiDARs filter echo signals through a set threshold, e.g., if the peak of the echo signal is higher than the set threshold, the echo signal is determined as a valid signal, or otherwise, the echo signal is determined as a noise).

### SUMMARY OF THE DISCLOSURE

In view of one or more defects in the prior art, this disclosure provides an emitter of a LiDAR, including: a substrate; and a plurality of lasers, arranged on the substrate in an array and configured to emit detection beams. A laser of the plurality of lasers is configured to emit a detection beam through a flat light emitting region. A size of the flat light emitting region in a first direction is greater than a size of the flat light emitting region in a second direction.

Optionally, the plurality of lasers are configured to emit a detection beam through the flat light emitting region.

Optionally, at least two lasers of the plurality of lasers are configured to emit a first detection beam through a first flat light emitting region, and remaining lasers of the plurality of lasers are configured to emit a second detection beam through a second light emitting region having sizes substantially the same in the first direction and the second direction,

Optionally, the substrate is divided into a first half region and a second half region along the second direction, the first half region is located in the second half region, and the at least two lasers are located in the first half region or located close to the second half region in the first half region

Optionally, at least two of the plurality of laser includes a plurality of light emitting points. The light emitting points are configured to be turned on and off. The flat light emitting region is formed by simultaneously turning on at least two of the light emitting points.

Optionally, the laser is a vertical-cavity surface-emitting laser.

Optionally, the flat light emitting region may be oval, rectangular, or polygonal.

Optionally, the size of the flat light emitting region in the first direction is at least twice as the size of the flat light emitting region in the second direction.

Optionally, the plurality of lasers are arranged into one column, or the plurality of lasers are staggered and arranged into a plurality of columns.

This disclosure further provides a LiDAR, including: an emitter, an emitter, including: a substrate; and a plurality of lasers, arranged on the substrate in an array and configured to emit detection beams, wherein a laser of the plurality of lasers is configured to emit a detection beam through a flat light emitting region, and a size of the flat light emitting region in a first direction is greater than a size of the flat light emitting region in a second direction; a receiver comprising detectors, wherein the detectors are configured to receive echoes formed by reflection of detection beams emitted by the plurality of lasers from an object, and convert the echoes into electrical signals; and a processor coupled to the receiver and configured to generate point cloud data based on the electrical signals.

Optionally, the first direction is a horizontal direction, and the second direction is a vertical direction.

Optionally, each of the plurality of lasers corresponds to a different field-of-view angle in the vertical direction, and the laser includes a laser having a field-of-view angle corresponding to a field-of-view angles below the horizontal direction.

Optionally, at least two lasers of the plurality of lasers are configured to emit the detection beam through the flat light emitting region, the at least two lasers include all lasers having field-of-view angles corresponding to angles below the horizontal direction, and lasers of the plurality of lasers having field-of-view angles corresponding to angles in and above the horizontal direction have light emitting regions with sizes substantially the same in the first direction and the second direction.

Optionally, at least two lasers of the plurality of lasers are configured to emit the detection beam through the flat light emitting region, the at least two of the lasers include all lasers having the field-of-view angles corresponding to angles between the horizontal direction and a preset negative angle, and the lasers having the field-of-view angles corresponding to the angles in and above the horizontal direction and lasers having the field-of-view angles corresponding to angles below the preset negative angle have light emitting regions with sizes substantially the same in the first direction and the second direction.

Optionally, flatness of the flat light emitting regions is configured to increase as field-of-view angles of the plurality of lasers approach the horizontal direction.

Optionally, the processor is configured to determine, for at least two of the electrical signals, whether the at least two electrical signals are valid signals or noise based on a first amplitude threshold, a second amplitude threshold, and a pulse width threshold, where the first amplitude threshold is higher than the second amplitude threshold.

Optionally, the at least two of the electrical signals are converted from the echoes formed by the reflection of the detection beams emitted by the laser through the flat light emitting regions from an object.

Optionally, for particular electrical signals converted from the echoes formed by the reflection of the detection beams emitted by lasers other than the laser from an object, whether the electrical signals are valid signals or noise is determined based on a third amplitude threshold.

Optionally, the processor is configured to determine an electrical signal higher than the first amplitude threshold as a valid signal; determine whether a pulse width of the electrical signal is greater than a pulse width threshold when the electrical signal is lower than or equal to the first amplitude threshold and higher than the second amplitude threshold; determine the electrical signal as the valid signal when the pulse width of the electrical signal is greater than the pulse width threshold; determine the electrical signal as noise when the pulse width of the electrical signal is lower than or equal to the pulse width threshold; and determine the electrical signal lower than or equal to the second amplitude threshold as noise.

Optionally, the processor is configured to determine a mean value and dispersion of base noise based on the electrical signals converted from echoes of the LiDAR; and determine the first amplitude threshold and the second amplitude threshold based on the mean value and dispersion of the base noise.

This disclosure further provides a method of detection for a LiDAR, including: emitting, by a plurality of lasers, detection beams to a target region, where a laser emits a detection beam through a flat light emitting region, and the flat light emitting region has a size in a first direction greater than a size in a second direction; receiving echoes formed by reflection of the detection beams from an object, converting the echoes into electrical signals; and generating point cloud data based on the electrical signals.

Optionally, the first direction is a horizontal direction, and the second direction is a vertical direction.

Optionally, each laser corresponds to a different field-of-view angle in the vertical direction, and the laser includes a laser having a field-of-view angles corresponding to an angles below the horizontal direction.

Optionally, at least two lasers emit the detection beam through the flat light emitting region, the at least two of the lasers comprise all lasers having field-of-view angles corresponding to angles below the horizontal direction, and lasers having field-of-view angles corresponding to angles in and above the horizontal direction have light emitting regions with sizes substantially the same in the first direction and the second direction.

Optionally, flatness of the flat light emitting region of the laser is configured to increase as field-of-view angles of the plurality of lasers approach the horizontal direction.

Optionally, the method further includes: determining, for at least two of the electrical signals, whether the at least two of the electrical signals are valid signals or noise through a first amplitude threshold, a second amplitude threshold, and a pulse width threshold, wherein the first amplitude threshold is higher than the second amplitude threshold.

Optionally, converting the at least two of the electrical signals from echoes formed by reflection of the detection beams emitted by the at least two of the lasers through flat light emitting regions from an object.

Optionally, determining, for particular electrical signals converted from echoes formed by reflection of detection beams emitted by lasers other than the at least two of the lasers from the object, whether the particular electrical signals are valid signals or noise based on a third amplitude threshold.

Optionally, the step of determining whether the electrical signals are valid signals or noise includes: determining an electrical signal higher than the first amplitude threshold as a valid signal; determining whether a pulse width of the electrical signal is greater than the pulse width threshold when the electrical signal is lower than or equal to the first amplitude threshold and higher than the second amplitude threshold; and determining the electrical signal as a valid signal when the pulse width of the electrical signal is greater than the pulse width threshold;

Optionally, the step of determining whether the electrical signals are valid signals or noise includes: determining the electrical signal as noise when the pulse width of the electrical signal is lower than or equal to the pulse width threshold; and determining the electrical signal lower than or equal to the second amplitude threshold as the noise.

Optionally, the method further includes: determining a mean value and dispersion of base noise based on the electrical signals converted from echoes of the LiDAR; and determining the first amplitude threshold and the second amplitude threshold based on the mean value and dispersion of the base noise.

This disclosure further provides a method of detection for a LiDAR, including: emitting detection beams to a target region; receiving echoes formed by reflection of the detection beams from an object, converting the echoes into electrical signals; selecting valid signals from the electrical signals; determining, for at least two of the electrical signals, whether the at least two of the electrical signals are valid signals or noise through a first amplitude threshold, a second amplitude threshold, and a pulse width threshold, where the first amplitude threshold is higher than the second amplitude threshold; and generating point cloud data based on the valid signals.

Optionally, the step of determining whether the at least some of the electrical signals are valid signals or noise includes: determining an electrical signal higher than the first amplitude threshold as a valid signal; determining whether a pulse width of the electrical signal is greater than the pulse width threshold when the electrical signal is lower than or equal to the first amplitude threshold and higher than the second amplitude threshold; and determining the electrical signal as the valid signal when the pulse width of the electrical signal is greater than the pulse width threshold;

Optionally, the step of determining whether the at least some of the electrical signals are valid signals or noise includes: determining the electrical signal as noise when the pulse width of the electrical signal is lower than or equal to the pulse width threshold; and determining the electrical signal lower than the second amplitude threshold as noise.

Optionally, the method further includes: determining a mean value and dispersion of base noise based on the electrical signals converted from echoes of the LiDAR; and determining the first amplitude threshold and the second amplitude threshold based on the mean value and dispersion of the base noise.

Optionally, emitting the detection beams to a target region is performed by a plurality of lasers. Each of the plurality of lasers corresponds to a different field-of-view angle in the vertical direction.

Optionally, the at least two of the electrical signals are electrical signals corresponding to detection beams emitted by part or all of lasers having field-of-view angles corresponding to angles below the horizontal direction.

Optionally, the at least some of the electrical signals are electrical signals corresponding to detection beams emitted by lasers with the field-of-view angles corresponding to angles between the horizontal direction and a preset negative angle.

Optionally, the step of selecting valid signals from the electrical signals includes: selecting, for particular electrical signals other than the at least two of the electrical signals, an electrical signal higher than a third amplitude threshold as a valid signal; or determining the particular electrical signals as noise when no electrical signal of the particular electrical signals is higher than the third amplitude threshold . . .

Optionally, at least two of the plurality of lasers are configured to emit a detection beam through a flat light emitting region, and a size of the flat light emitting region in the horizontal direction is greater than a size of the flat light emitting region in the vertical direction.

Optionally, the at least two of the plurality of lasers comprise part or all of lasers having field-of-view angles corresponding to angles below the horizontal direction.

Optionally, the plurality of lasers are configured to emit the detection beam through the flat light emitting region.

Optionally, the at least two of the plurality of lasers comprise all lasers having field-of-view angles corresponding to angles below the horizontal direction, and lasers having field-of-view angles corresponding to angles in and above the horizontal direction have light emitting regions with sizes substantially the same in the horizontal direction and the vertical direction.

Optionally, the at least two of the lasers comprise all lasers having field-of-view angles corresponding to angles between the horizontal direction and a preset negative angle, and the lasers having the field-of-view angles corresponding to the angles in or above the horizontal direction and lasers having field-of-view angles corresponding to angles below the preset negative angle have light emitting regions with sizes substantially the same in the horizontal direction and the vertical direction.

Optionally, flatness of the flat light emitting region of the at least two of the plurality of lasers is configured to increase as field-of-view angles of the plurality of lasers approach the horizontal direction.

Optionally, the at least two of the plurality of lasers include a plurality of light emitting points, the light emitting points are configured to be turned on and off, and the flat light emitting region is formed by simultaneously turning on at least two of the light emitting points.

Optionally, a size of the flat light emitting region in the horizontal direction is at least twice as a size in the vertical direction.

This disclosure further provides a LiDAR, including: an emitter, configured to emit detection beams to a target region; a receiver, configured to receive echoes formed by reflection of the detection beams from an object, and convert the echoes into electrical signals; and a processor, coupled to the receiver and configured to select valid signals from the electrical signals, determine, for at least two of the electrical signals, whether the at least two of the electrical signals are valid signals or noise through a first amplitude threshold, a second amplitude threshold, and a pulse width threshold, where the first amplitude threshold is higher than the second amplitude threshold, and generate point cloud data based on the valid signals.

Optionally, the processor is configured to: determine an the electrical signal higher than the first amplitude threshold as a valid signal; determine whether a pulse width of the electrical signal is greater than the pulse width threshold when the electrical signal is lower than or equal to the first amplitude threshold and higher than the second amplitude threshold; determine the electrical signal as the valid signal when the pulse width of the electrical signal is greater than the pulse width threshold; determine, filter out the electrical signal as noise when the pulse width of the electrical signal is lower than or equal to the pulse width threshold; and determine the electrical signal lower than the second amplitude threshold as the noise.

Optionally, the processor is configured to determine a mean value and dispersion of base noise based on the electrical signals converted from echoes of the LiDAR; and determine the first amplitude threshold and the second amplitude threshold based on the mean value and dispersion of the base noise.

Optionally, the emitter includes a plurality of lasers. The lasers are configured to emit the detection beams. Each of the plurality of lasers corresponds to a different field-of-view angle in the vertical direction.

Optionally, the at least two of the electrical signals are electrical signals corresponding to detection beams emitted by part or all of lasers having field-of-view angles corresponding to angles below the horizontal direction.

Optionally, the at least two of the electrical signals are electrical signals corresponding to detection beams emitted by lasers having the field-of-view angles corresponding to angles between the horizontal direction and a preset negative angle.

Optionally, the processor is configured to determine, for particular electrical signals other than the at least two of the electrical signals, a particular electrical signal higher than a third amplitude threshold as a valid signal, or otherwise, determine the particular electrical signals as noise when no electrical signal of the particular electrical signals is higher than the third amplitude threshold.

Optionally, at least two of the plurality of lasers are configured to emit a detection beam through a flat light emitting region, and a size of the flat light emitting region in the horizontal direction is greater than a size of the flat light emitting region in the vertical direction.

Optionally, the at least two of the plurality of lasers comprise part or all of lasers having field-of-view angles corresponding to angles below the horizontal direction.

Optionally, the plurality of lasers are configured to emit the detection beam through the flat light emitting region.

Optionally, the at least two of the plurality of lasers comprise all lasers having field-of-view angles corresponding to angles below the horizontal direction, and lasers having field-of-view angles corresponding to angles in and above the horizontal direction have light emitting regions with sizes substantially the same in the horizontal direction and the vertical direction.

Optionally, the at least two of the plurality of lasers comprise all lasers having the field-of-view angles corresponding to angles between the horizontal direction and a preset negative angle, and the lasers having the field-of-view angles corresponding to the angles in and above the horizontal direction and lasers having field-of-view angles corresponding to angles below the preset negative angle have light emitting regions with sizes substantially the same in the horizontal direction and the vertical direction.

Optionally, flatness of the light emitting region of the at least two of the plurality of lasers is configured to increase as field-of-view angles of the plurality of lasers approach the horizontal direction.

Optionally, the at least two of the plurality of lasers comprise a plurality of light emitting points, the light emitting points are configured to be turned on and off, and the flat light emitting region is formed by simultaneously turning on at least two of the light emitting points.

Optionally, a size of the flat light emitting region in the horizontal direction is at least twice as a size in the vertical direction.

Compared with the prior art, embodiments of this disclosure provide an emitter, a LiDAR, and a detection method.

By configuring at least some of the lasers of the emitter to emit detection beams through the flat light emitting regions, the far-field divergence angle, in the second direction, of the detection beams emitted by these lasers can be reduced, such that the longitudinal size of spots formed after oblique incidence of the detection beams emitted by these lasers to the ground is small, broadening of echoes (electrical signals) can be compressed, peaks of the echoes (electrical signals) are increased (e.g., echoes are not short and fat, but taller and thinner), and the over-threshold probability of the echoes (electrical signals) is increased, making the valid signals not likely to be omitted, and enhancing the detection capability of the LiDAR to the ground.

Whether at least some of the electrical signals are valid signals is determined through a first amplitude threshold, a second amplitude threshold, and a pulse width threshold. The determination result is more accurate, and identification of the valid signals is improved to detect more valid signals, making the valid signals not likely to be omitted, and enhancing the detection capability of the LiDAR to the ground. Whether other electrical signals are valid signals is determined through a third amplitude threshold, and therefore the processing efficiency of the LiDAR can be improved, and the processing time can be shortened.

### BRIEF DESCRIPTION OF THE DRAWINGS

The accompanying drawings are used to provide a further understanding of this disclosure and form part of the specification. They are used together with the embodiments of this disclosure to explain this disclosure without constituting a limitation to this disclosure. In the accompanying drawings:

FIG. 1 shows a schematic diagram of a laser beam obliquely incident to the ground and reflected by the ground.

FIG. 2 shows a schematic diagram of incidence of an example laser beam to a target object in normal and oblique manners, consistent with some embodiments of this disclosure.

FIG. 3a shows a side view of light emission of an example laser of a LiDAR, consistent with some embodiments of this disclosure.

FIG. 3b shows a top view of light emission of an example laser of the LiDAR, consistent with some embodiments of this disclosure;

FIG. 4a shows a schematic diagram of a detection beam of a LiDAR obliquely incident to the ground and forms a corresponding spot and echo;

FIG. 4b shows a schematic diagram of a detection beam of an example LiDAR

obliquely incident to the ground and forms a corresponding spot and echo, consistent with some embodiments of this disclosure;

FIG. 5 shows a schematic diagram of an example emitter, consistent with some embodiments of this disclosure;

FIG. 6 shows a schematic diagram of another example emitter, consistent with some embodiments of this disclosure;

FIG. 7 shows a schematic diagram of oblique incidence of two example detection beams to the ground with different incidence angles to form spots and echoes, consistent with some embodiments of this disclosure;

FIG. 8 shows a schematic diagram of an example emitter, consistent with some embodiments of this disclosure;

FIG. 9 shows a schematic diagram of an example laser, consistent with some embodiments of this disclosure;

FIG. 10 shows a schematic structural diagram of an example LiDAR, consistent with some embodiments of this disclosure;

FIG. 11 shows a schematic diagram of an example LiDAR emitting detection beams and receiving echoes, consistent with some embodiments of this disclosure;

FIG. 12 shows a flowchart of an example method of determining whether an electrical signal is a valid signal or noise, consistent with some embodiments of this disclosure;

FIG. 13 shows a schematic diagram of an example electrical signal, consistent with some embodiments of this disclosure;

FIG. 14 shows a flowchart of an example method of calculating a first amplitude threshold and a second amplitude threshold, consistent with some embodiments of this disclosure;

FIG. 15 shows a flowchart of an example method of determining whether an electrical signal is a valid signal or noise, consistent with some embodiments of this disclosure;

FIG. 16 shows a flowchart of an example method of detection for a LiDAR, consistent with some embodiments of this disclosure;

FIG. 17 shows a flowchart of an example method of detection for a LiDAR, consistent with some embodiments of this disclosure;

FIG. 18 shows a schematic structural diagram of an example LiDAR, consistent with some embodiments of this disclosure.

FIG. 19 shows a schematic diagram of an example LiDAR emitting detection beams and receiving echoes, consistent with some embodiments of this disclosure.

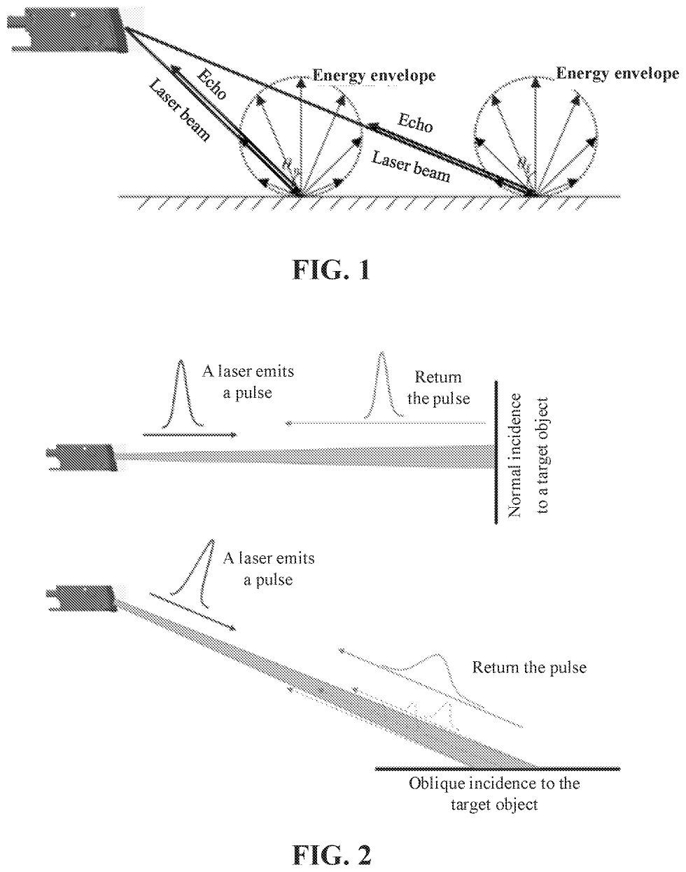

### DETAILED DESCRIPTION

Hereinafter, some example embodiments are described. As those skilled in the art may recognize, the embodiments may be modified in a variety of different ways in the scope of this disclosure. Accordingly, the drawings and description are considered to be essentially illustrative, without limiting the scope of this disclosure.

It should be understood that orientation or position relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, or the like are orientation or position relationships shown in the illustrations, are only used to simplify the description, and thus should not be understood as limitations to this disclosure. In addition, the terms “first” and “second” are used for the purpose of description only and cannot be understood as indicating or implying relative importance or implicitly indicating the number of technical features indicated. As a result, a feature defined by “first” or “second” may explicitly or implicitly include one or more of such features. In the description of this disclosure, “plurality of” means two or more, unless otherwise expressly and specifically limited.

It should be noted that, the terms “mount,” “link,” and “connect” should be understood in a broad sense. For example, it can be a fixed connection, a detachable connection, or an integrated connection; it can be a mechanical connection, an electrical connection, or a mutual communication; and it can be a direct connection or an indirect connection through an intermediate medium, a communication between interiors of two elements, or an interaction relationship of the two elements. For those of ordinary skill in the art, the meanings of the above terms in this disclosure can be understood based on context.

In this disclosure, unless otherwise expressly specified and limited, a first feature being “above” or “below” a second feature can include direct contact of the first feature and the second feature, and can also include indirect contact of the first feature and the second feature through an additional feature therebetween. Further, the first feature being “over”, “above”, and “on” the second feature includes the first feature being over or above the second feature, or merely indicates that the horizontal height of the first feature is higher than that of the second feature. The first feature being “under”, “below”, and “underneath” the second feature includes the first feature being under or below the second feature, or merely indicates that the horizontal height of the first feature is lower than that of the second feature.

There are many different example embodiments for implementing different structures of this disclosure. To simplify the disclosure, components and arrangements in the embodiments are described below. Of course, they are merely examples, and are not intended to limit this disclosure. Further, in this disclosure, reference numerals and/or reference letters can be repeated in different examples, and such repetition is for simplification and clarity purposes and does not indicate a relationship between the various embodiments and/or arrangements being discussed. In addition, this disclosure provides examples of various processes and materials, but those skilled in the art can realize the application of other processes and/or other materials.

The embodiments are described below together with the illustrations. It should be understood that the embodiments described here are used to illustrate and explain this disclosure, and are not intended to be a limitation.

In some existing techniques, in an emitter of a LiDAR, light emitting regions of lasers typically have a shape with same size in directions in two dimensions. When detection light of the LiDAR is obliquely incident to the ground, there is an obvious echo broadening with a low peak value. However, in this disclosure, by arranging light emitting regions of at least some lasers with different sizes in the two-dimensional direction, and therefore the problems of echo broadening, and the low peak can be significantly reduced or solved. The following is a detailed description.

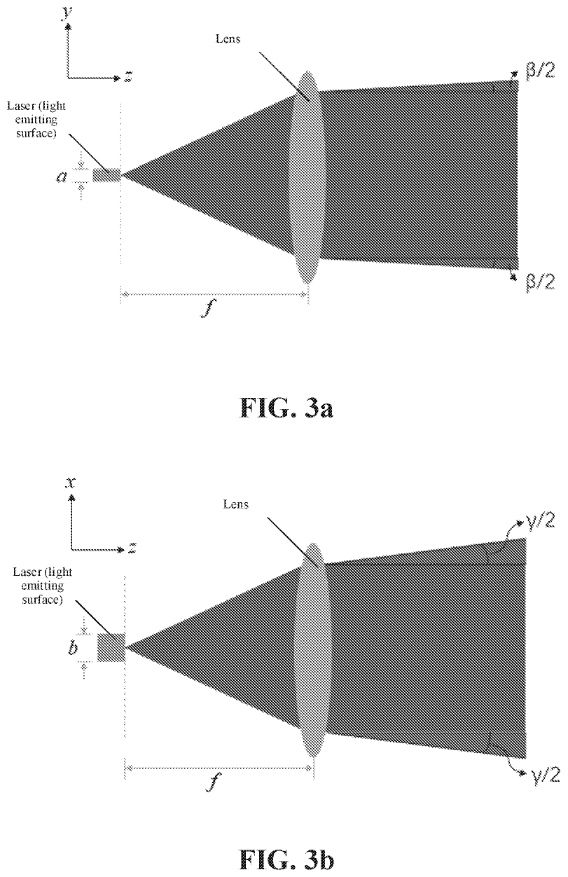

FIG. 3a shows a side view of light emission of a laser of an example LiDAR consistent with some embodiments of this disclosure. FIG. 3b shows a top view of light emission of an example laser of the LiDAR consistent with some embodiments of this disclosure. A beam emitted by the laser is collimated by a lens and then emitted to the outside of the LiDAR. In FIG. 3a and FIG. 3b, based on a typical installation orientation of the LiDAR on a vehicle, y direction is a vertical height direction, z direction is a vehicle forward direction, and x direction is a transverse direction of the vehicle, namely, a direction perpendicular to the vehicle forward direction in a horizontal plane. A light emitting region of the laser has a longitudinal size a and a transverse size b.

For example, as shown in FIG. 3a and FIG. 3b, although the beam emitted by the laser is collimated through the lens, due to a non-point light source, the collimated beam still has a certain far-field divergence angle. The far-field divergence angle is determined by the size of a light emitting surface and a focal length f of the lens. For the longitudinal direction (y direction in FIG. 3a): the longitudinal size of the light emitting surface is a, and therefore a longitudinal far-field divergence angle β in the y direction can be described as

$$β = 2 \times arctan ( \frac{a}{2 f} ) .$$

For the transverse direction (x direction in FIG. 3b), the transverse size of the light emitting surface is b, and a transverse far-field divergence angle γ can be described as

$$γ = 2 \times arctan ( \frac{b}{2 f} ) .$$

Based on this disclosure, the size of the light emitting surface of the laser along the first direction (x direction) b is set to be larger than the size in the second direction (y direction) a, that is, b is greater than a, so that it can relatively reduce the longitudinal far-field divergence angle β. While, the size of the light emitting surface of the laser along the first direction (x direction) b is substantially the same as the size in the second direction (y direction) a, that is, b˜a. In this case, the longitudinal far-field divergence angle β is substantially the same as the transverse far-field divergence angle γ. Therefore, this disclosure can reduce or solve the problems of echo broadening and the low peak.

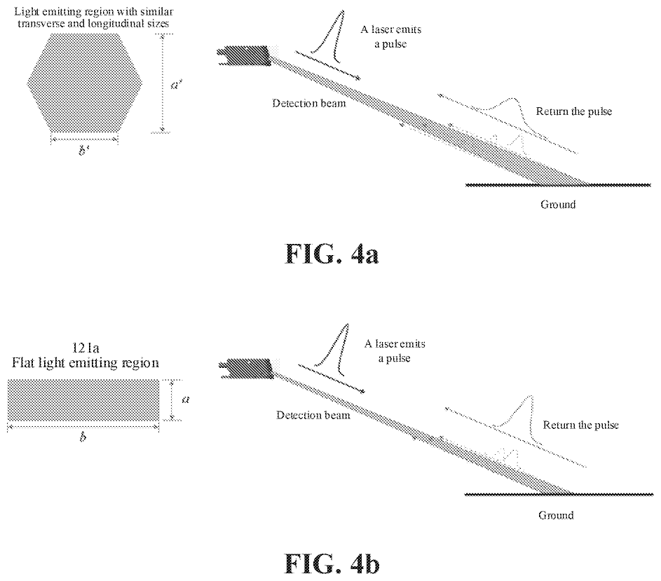

FIG. 4a shows a schematic diagram of a detection beam of a LiDAR obliquely incident to the ground and forms a corresponding spot and echo. FIG. 4b shows a schematic diagram of a detection beam of an example LiDAR obliquely incident to the ground and forms a corresponding spot and echo, consistent with some embodiments of this disclosure.

For example, as shown in FIG. 4a, a laser of the LiDAR has a light emitting region with similar transverse and longitudinal sizes. The transverse size b′ is approximately equal to the longitudinal size a′. Therefore, the longitudinal far-field divergence angle and the longitudinal size of the spot are both large. It is represented in that, the spread length along the ground is large after projection onto the ground. Therefore, after echoes within the length range are superimposed, the echo pulse is broadened significantly, and the peak is low. For example, as shown in FIG. 4b, the LiDAR using the laser uses a flat light emitting region, with a small longitudinal size a and a transverse size b, where b can be significantly greater than the longitudinal size a. Therefore, a longitudinal far-field divergence angle is small, and a longitudinal size of a spot is small. It is represented in that, a spread length along the ground is small after projection to the ground, and therefore when echoes within the length range are superimposed, the echo pulse is concentrated more obviously and has a high peak. It thus can improve the detection capability of the LiDAR to the ground.

Lasers having light emitting regions with different transverse and longitudinal sizes to the emitter of a LiDAR are provided in this disclosure. The following is a detailed description of example embodiments of this disclosure.

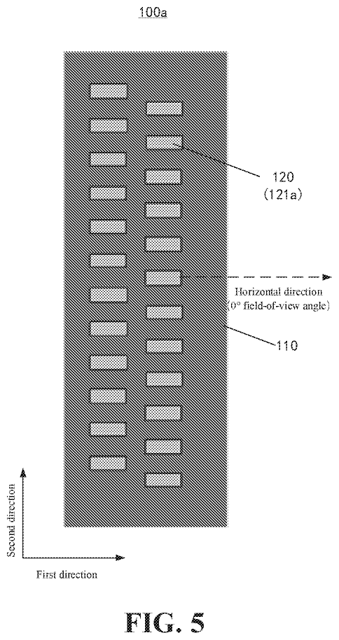

For example, FIG. 5 shows a schematic diagram of an example emitter, consistent with some embodiments of this disclosure. A detailed description is as below consistent with FIG. 5.

For example, as shown in FIG. 5, the emitter 100a includes a substrate 110 (e.g., circuit board) and a plurality of lasers 120. The plurality of lasers 120 are arranged on the substrate 110 in an array, and the emitter 100a includes one or more transmission circuit boards. To improve system integration, all the lasers can be arranged on one transmission circuit board. The laser 120 can emit a detection beam (laser beam) and the laser 120 can be, for example, a vertical-cavity surface-emitting laser (“VCSEL”). Among the plurality of lasers 120, at least some of the lasers 120 can emit a detection beam through a flat light emitting region 121a. The size of the flat light emitting region 121a in a first direction is greater than the size in a second direction, where the first direction is perpendicular to the second direction. In the application to a vehicle-mounted LiDAR, the first direction is, for example, a horizontal direction, and the second direction is a vertical direction.

In some embodiments, for example, as shown in FIG. 4, the flat light emitting region 121a can be rectangular to facilitate the design and manufacture of the laser 120, but this embodiment is not limited to this. In other embodiments, the flat light emitting region 121a can also be of other polygons or ellipses.

In some embodiments, for example, as shown in FIG. 4, the size of the flat light emitting region 121a in the first direction is two or more times (e.g., 2-4 times) the size in the second direction, so as to reduce the longitudinal far-field divergence angle of the corresponding laser 120, and further reduce the longitudinal size of the spot formed after oblique incidence of the detection beam to the distant ground to make echo broadening less obvious. For example, the size of the flat light emitting region 121a in the first direction is about three times the size in the second direction.

In some embodiments, for example, as shown in FIG. 5, the plurality of lasers 120 are staggered and arranged into a plurality of columns, so as to improve an angular resolution of the LiDAR. In other embodiments, the plurality of lasers 120 can also be arranged in one column. In an embodiment of a multi-column arrangement, light emitting regions of the lasers in different columns are preferably staggered.

In some embodiments, for example, as shown in FIG. 5, the plurality of lasers 120 all can emit a detection beam through a flat light emitting region 121a.

In the embodiment of FIG. 5, all the lasers have the flat light emitting regions, but this disclosure is not limited to this, and it is possible that some of the lasers can use the flat light emitting regions.

Compared with a laser that emits a detection beam through a light emitting region with similar transverse and longitudinal sizes (sizes in the first direction and the second direction are substantially the same), the laser 120 that emits a detection beam through a flat light emitting region 121a has a larger transverse far-field divergence angle, such that the transverse point cloud quality contrast of a point cloud generated by the LiDAR is reduced. Therefore, some of the lasers use the flat light emitting regions based on operation requirements of the LiDAR. It should be noted that the light emitting region with the similar transverse and longitudinal sizes and the light emitting region with the longitudinal size obviously less than the transverse size are substantially the same in arca, so as to ensure that the emission energy of each laser is substantially the same.

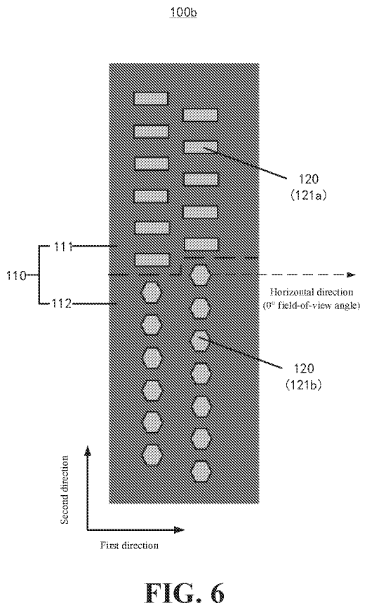

FIG. 6 shows a schematic diagram of another example emitter, consistent with some embodiments of this disclosure. For example, as shown in FIG. 6, the substrate 110 is divided into a first half region 111 and a second half region 112 along the second direction (e.g., the first half region 111 and the second half region 112 are bounded by a dashed line in FIG. 6). When the emitter 100b is applied to the LiDAR, the first half region 111 is located on the second half region 112. In the emitter 100b, some of the lasers 120 can emit a detection beam through a flat light emitting region 121a, and the rest of the lasers 120 can emit detection beams through light emitting regions 121b, where the light emitting regions 121b have sizes that are substantially the same in the first direction and the second direction. For example, as shown in FIG. 6, at least some of the lasers 120 mentioned above can be all the lasers located in the first half region 111. For example, all the lasers 120 in the first half region 111 can emit detection beams through the flat light emitting regions 121a. For example, all the lasers 120 in the second half region 112 can emit detection beams through the light emitting regions 121b, where the light emitting regions 121b have sizes substantially the same in the first direction and the second direction.

When the emitter 100b is applied to the LiDAR, the lasers 120 in the first half region 111 can emit the detection beams to the ground (below a horizontal direction), such that the LiDAR obtains a strong detection capability for the ground. The lasers 120 in the second half region 112 can emit the detection beams in the horizontal direction and above (including the horizontal direction). Therefore the quality contrast of the transverse point cloud can be maintained in fields of view in or above the horizontal direction. The horizontal direction here can also include: the field of view of the LiDAR being 0°; emitting detection beams below the horizontal direction corresponds to field of view below 0°; and emitting the detection beams towards the horizontal direction and above refers to field of view being 0° or above (including 0°). A corresponding relationship between the position of the laser and the direction for emitting the detection beam is described in detail below.

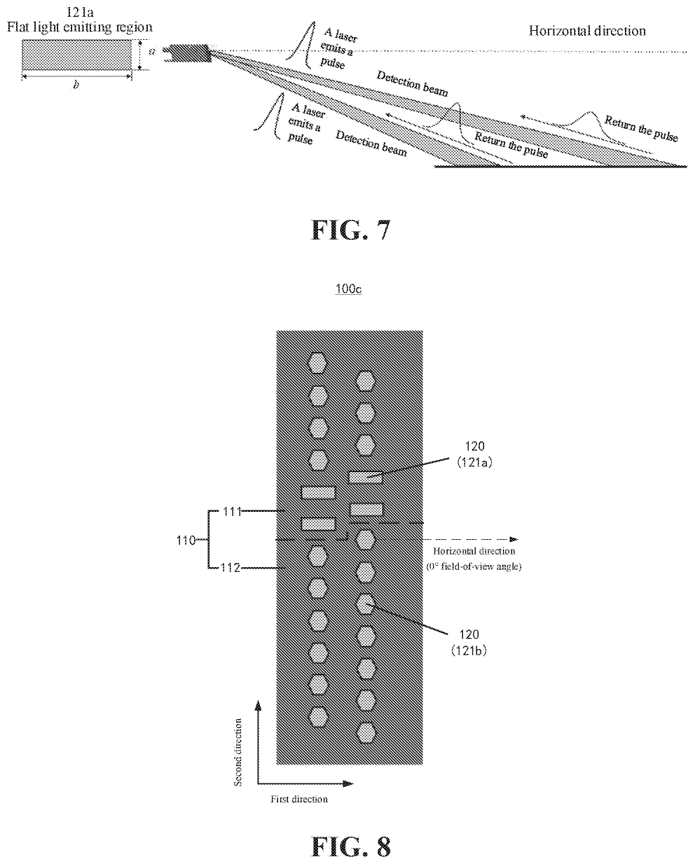

FIG. 7 shows a schematic diagram of oblique incidence of two example detection beams to the ground with different incidence angles to form spots and echoes, consistent with some embodiments of this disclosure. For example, as shown in FIG. 7, the larger the incidence angle that the detection beams are incident to the ground (the oblique downward emission angle of the detection beams is closer to the horizontal direction), the more obvious the broadening of the formed echoes. Therefore the lasers 120, close to the second half region 112, in the first half region 111 can emit detection beams through the flat light emitting regions 121a. For example, FIG. 8 shows a schematic diagram of an example emitter consistent with some embodiments of this disclosure. For example, as shown in FIG. 6 and FIG. 8, the emitter 100c and the emitter 100b are different in that, in the emitter 100c, at least some of the lasers 120 can be lasers 120, close to a second half region 112, in a first half region 111. For example, the lasers 120, close to the second half region 112, in the first half region 111 can emit a detection beam through a flat light emitting region 121a, and all lasers 120 in the second half region 112 and lasers 120, away from the second half region 112, in the first half region 111 can emit detection beams through light emitting regions 121b having sizes in the first direction and the second direction substantially the same.

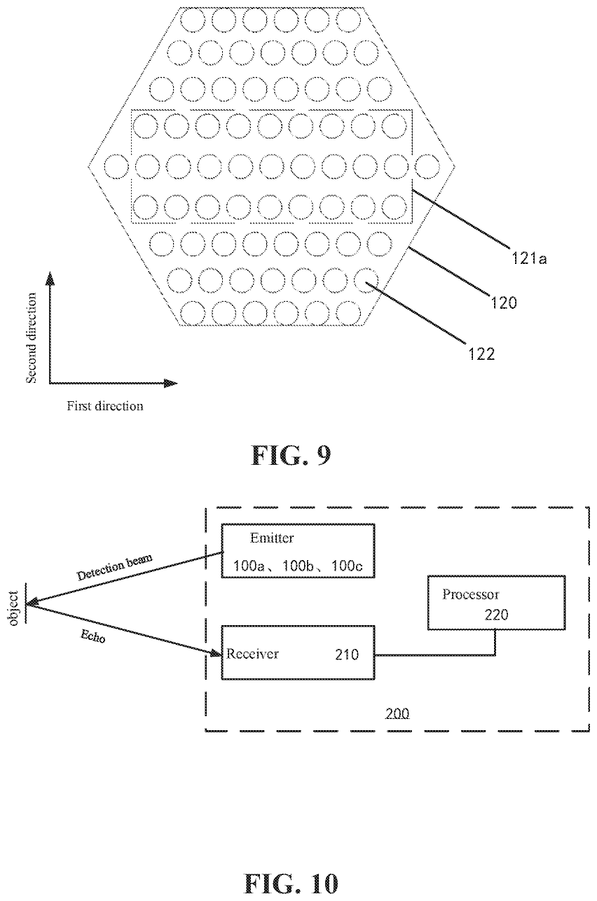

FIG. 9 shows a schematic diagram of an example laser consistent with some embodiments of this disclosure. For example, as shown in FIG. 9, the laser 120 can include a plurality of light emitting points 122. The light emitting points 122 can be turned on and off. The flat light emitting region 121a is formed by simultaneously turning on some of the light emitting points 122 within the laser 120. Through such an arrangement, the light emitting regions of laser 120 can be dynamically adjusted based on the actual situation. For example, the light emitting regions can have different shapes and sizes (sizes in the first direction and the second direction) based on locations of the lasers 120.

The emitters based on the embodiments of this disclosure are described in a usage scenario of the LiDAR. Those skilled in the art easily understand that the emitter of this disclosure is not limited to be used in the LiDAR, and can also be applied to other optoelectronic devices. Based on different detection requirements and scenarios, at least some of the lasers of the emitter emit detection beams through the flat light emitting regions, making the echo pulses obvious and more concentrated with high peaks, thereby enhancing detection capabilities.

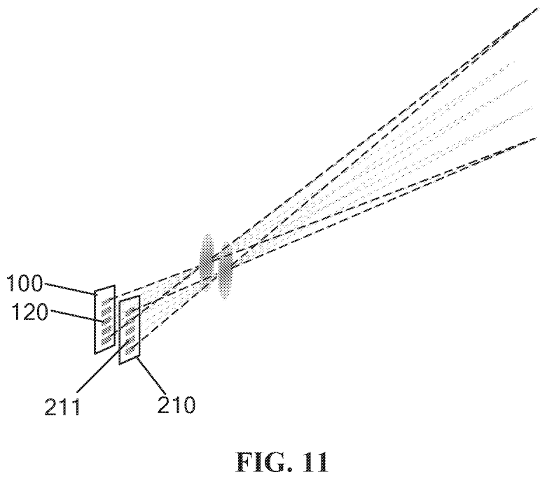

FIG. 10 shows a schematic structural diagram of an example LiDAR consistent with some embodiments of this disclosure. FIG. 11 shows a schematic diagram of an example LiDAR emitting detection beams and receiving echoes consistent with some embodiments of this disclosure. A detailed description is made consistent with FIG. 10 and FIG. 11 below.

For example, as shown in FIG. 10 and FIG. 11, the LiDAR 200 includes the above emitter 100a, 100b, or 100c, and further includes a receiver 210 and a processor 220. The receiver 210 includes detectors 211. The detectors 211 can receive echoes formed by the reflection of the detection beams emitted by the lasers 120 from an object (e.g., obstacle), and convert the echoes into electrical signals. The processor 220 is coupled to the receiver 210, and can generate point cloud data based on the electrical signals.

For example, a first direction of the emitter is a horizontal direction, and a second direction is a vertical direction. Each laser in the emitter corresponds to a different field-of-view angle in the vertical direction (e.g., −20° to +20°). For example, as shown in FIG. 4, at least some of the lasers 120 (e.g., lasers 120 emitting the detection beams through the flat light emitting regions 121a) include all lasers 120 in the emitter 100a, namely, lasers 120 with field-of-view angles corresponding to all field-of-view angles.

Compared with a laser that emits a detection beam through a light emitting region with similar transverse and longitudinal sizes (sizes in the first direction and the second direction are substantially the same), the laser 120 that emits a detection beam through a flat light emitting region 121a has a small longitudinal far-field divergence angle, a spot formed after oblique incidence of the detection beam emitted by the laser 120 to the distant ground has a small longitudinal size, leading to less obvious echo broadening, thereby improving the detection capability of the LiDAR 200 to the ground. However, the transverse far-field divergence angle of the laser 120 emitting the detection beam through the flat light emitting region 121 is larger, causing a decrease in the transverse point cloud quality contrast of point clouds generated by the LiDAR 200, and therefore to improve the detection capability of the LiDAR 200 to the ground and keep the point cloud quality of the point clouds generated by the LiDAR 200 at a high level, only light emitting regions of lasers 120 with the field-of-view angles corresponding to part or all of field-of-view angles below the horizontal direction can be set to be flat, that is, at least some of the lasers 120 include lasers 120 with the field-of-view angles corresponding to part or all of field-of-view angles below the horizontal direction.

For example, as shown in FIG. 11, FIG. 11 schematically shows that an emitter 100 includes 5 lasers 120. The 5 lasers 120 emit detection beams. Echoes formed by the reflection of the detection beams from an object are received by the corresponding detectors 211 in the receiver 210. The lasers located at an upper portion of the emitter 110 (2 lasers 120 located above in the figure, e.g., corresponding to the lasers in the first half region 111 of the emitter 110 in FIG. 6) emit detection beams below the horizontal direction (e.g., obliquely emitting detection beams downward). The lasers located at a lower portion of the emitter 110 (3 lasers 120 located below in the figure, e.g., corresponding to the lasers in the second half region 112 of the emitter 110 in FIG. 6) emit detection beams in the horizontal direction and above (the two lasers 120 located at the bottom obliquely emit detection beams above, and the one laser located in the middle emits a detection beam in the horizontal direction).

For example, for example, as shown in FIG. 6, the emitter 100b is vertically arranged. The first half region 111 of the substrate 110 is located on the second half region 112. The field-of-view angles of the lasers 120 in the first half region 111 correspond to all field-of-view angles below the horizontal direction (e.g., −20° to −1°, in this case, −1° is the negative angle closest to the field-of-view angle 0°). The field-of-view angles of the lasers 120 in the second half region 112 correspond to all field-of-view angles (e.g., 0° to +20° in the horizontal direction and above (including the horizontal direction). All the lasers 120 in the first half region 111 can emit detection beams through the flat light emitting regions 121a (e.g., at least some of the lasers 120 include lasers 120 with the field-of-view angles corresponding to all field-of-view angles below the horizontal direction).

The flatness of the light emitting regions of the some of the lasers 120 increases as the field-of-view angles of the lasers approach the horizontal direction, and the flatness of the light emitting regions becomes larger. For example, the ratio of the size of each light emitting region in the horizontal direction to the size in the second direction is larger.

For example, the lasers 120 with the field-of-view angles corresponding to the horizontal direction and above have the light emitting regions 121b with the sizes that are substantially the same in the first direction and the second direction. For example, as shown in FIG. 6, all the lasers 120 in the second half region 112 can be configured with the light-emitting regions 121b with the sizes that are substantially the same in the first direction and the second direction.

In some embodiments, at least some of the lasers 120 can include all lasers 120 with field-of-view angles corresponding to angles between the horizontal direction and a preset negative angle. For example, as shown in FIG. 8, the emitter 100c is vertically arranged. The first half region 111 of the substrate 110 is located on the second half region 112. The field-of-view angles of the lasers 120 in the first half region 111 correspond to all field-of-view angles below the horizontal direction (e.g., −20° to −1°). The field-of-view angles of the lasers 120 in the second half region 112 correspond to all field-of-view angles (e.g., 0° to +20°) in the horizontal direction and above (including the horizontal direction). As the lasers 120 in the first half region 111 approach the second half region 112, the corresponding field-of-view angle is closer to 0°, and the lasers 120 with the field-of-view angles corresponding to −5° to −1° in the first half region 111 can emit detection beams through the flat emitting regions 121a.

For example, the lasers 120 with the field-of-view angles corresponding to angles in the horizontal direction and above or below the preset negative angle have the light emitting regions 121b with the sizes that are substantially the same in the first direction and the second direction. For example, as shown in FIG. 8, all the lasers 120 in the second half region 112 are configured with the light emitting regions 121b with the sizes that are substantially the same in the first direction and the second direction. The lasers 120 with the field-of-view angles corresponding to −5° or below in the first half region 111 have the light emitting regions 121b with the sizes that are substantially the same in the first direction and the second direction.

The above description is about configuring at least some of the lasers to emit detection beams through the flat light emitting regions, thereby reducing or solving the problems of echo broadening and the low peak. Based on another embodiment of this disclosure, as the detection distance increases, for the potential problems of echo broadening and the low peak, valid signal identification can be enhanced by setting a double amplitude threshold. The following is a detailed description.

In the LiDAR, the processor typically compares the electrical signal with a preset amplitude threshold. When an amplitude of the electrical signal is greater than the amplitude threshold, the electrical signal is identified as a valid signal; or otherwise, the electrical signal is identified as noise. The setting of the amplitude threshold can be comprehensively considered. If the amplitude threshold is set too high, the valid signal is likely to lose; and if the setting is too low, excessive noise is likely to be introduced, causing a too low signal-to-noise ratio. In some embodiments of this disclosure, a first amplitude threshold and a second amplitude threshold are set for at least some of the electrical signals, to determine whether the electrical signals are valid signals or noise in conjunction with a pulse width threshold.

For example, the processor 220 can determine, for at least some of the electrical signals, whether the electrical signals are valid signals or noise through the first amplitude threshold, the second amplitude threshold, and the pulse width threshold, where the first amplitude threshold is higher than the second amplitude threshold.

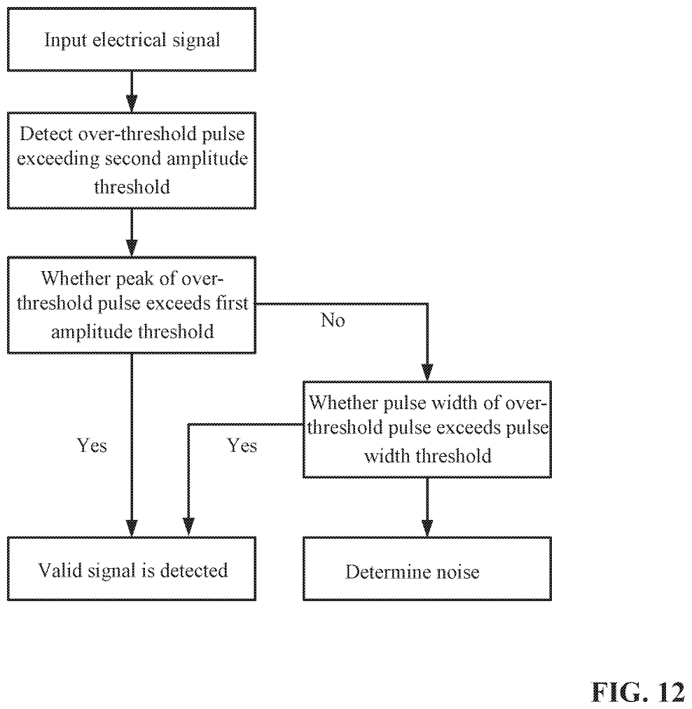

FIG. 12 shows a flowchart of an example method of determining, whether an electrical signal is a valid signal or noise consistent with some embodiments of this disclosure. For example, as shown in FIG. 12, after the electrical signal is inputted to the processor 220, an over-threshold pulse exceeding the second amplitude threshold is detected, and a pulse that does not exceed the second amplitude threshold may be determined as noise. Whether a peak of the over-threshold pulse exceeds the first amplitude threshold is determined. If the peak of the over-threshold pulse exceeds the first amplitude threshold, the electrical signal is determined as a valid signal, and detected as a valid signal. If the peak of the over-threshold pulse is less than the first amplitude threshold, whether a pulse width of the over-threshold pulse is greater than the pulse width threshold is determined. If the pulse width of the over-threshold pulse is greater than the pulse width threshold, the electrical signal is determined as a valid signal and detected as a valid signal. If the pulse width of the over-threshold pulse is less than the pulse width threshold, the electrical signal is determined as noise to be filtered out, or alternatively, the electrical signal can be marked as noise.

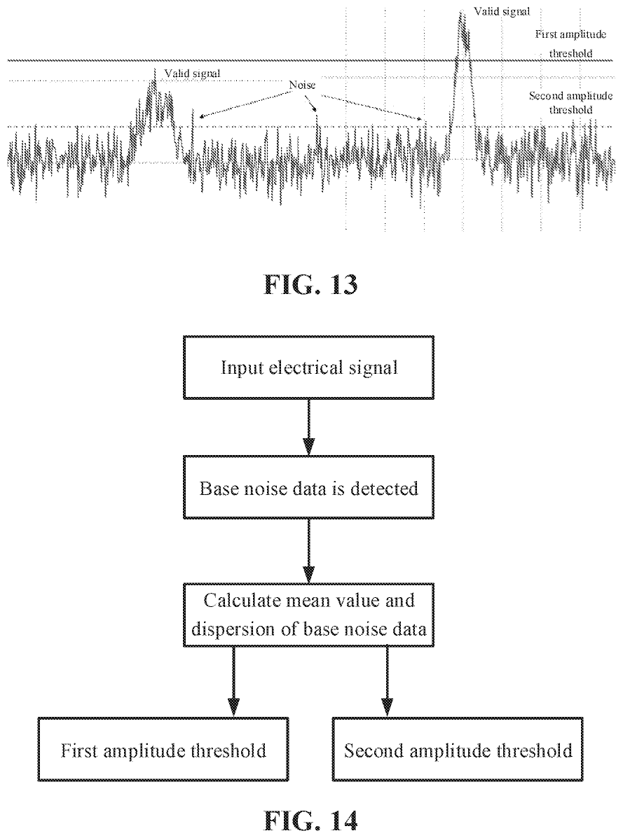

FIG. 13 shows a schematic diagram of an example electrical signal consistent with some embodiments of this disclosure. For example, as shown in FIG. 13, whether the electrical signal is a valid signal or noise is determined based on a first amplitude threshold, a second amplitude threshold, and a pulse width threshold. When the electrical signal is higher than the first amplitude threshold, the electrical signal is determined as a valid signal. When the electrical signal is lower than the first amplitude threshold, and higher than the second amplitude threshold, whether a pulse width of the electrical signal is greater than the pulse width threshold is determined; and when the pulse width of the electrical signal is greater than the pulse width threshold, the electrical signal is determined as a valid signal, or otherwise, the electrical signal is determined as noise.

After a detection beam emitted by a laser 120 is obliquely incident to a distant ground, a spot formed by the detection beam is elongated, making an echo short and fat, and the corresponding electrical signal (valid signal) becomes short and fat as well (low peak and large pulse width) while the peak and pulse width of the noise are typically low. By setting a low second amplitude threshold, the over-threshold probability of the noise and the valid signal can be increased. The pulse width of the electrical signal with the peak higher than the second amplitude threshold is detected through the pulse width threshold, such that the noise can be filtered out, and the valid signal is obtained. The valid signal is not likely to be omitted, and therefore the detection capability of the LiDAR 200 to the ground can be effectively enhanced.

The at least some of the electrical signals are converted from echoes formed by the reflection of the detection beams emitted by the flat light emitting regions 121a of the at least some of the lasers 120 from the object. The pulse width threshold is typically a preset value, and the first amplitude threshold and the second amplitude threshold can be preset values, and can also be calculated by the processor 220 based on the electrical signal. FIG. 14 shows a flowchart of an example method of calculating, a first amplitude threshold and a second amplitude threshold consistent with some embodiments of this disclosure. For example, as shown in FIG. 14, the processor 220 can determine a mean value and dispersion of base noise (e.g., baseline noise) based on the electrical signals converted from echoes of the LiDAR 200. The first amplitude threshold and the second amplitude threshold are determined based on the mean value and dispersion of base noise. The above process can be carried out before the LiDAR performs official detection, and the first amplitude threshold and the second amplitude threshold are saved in a system and kept stable within a period of time. When environmental conditions (e.g., lighting) change significantly, the above process is repeated.

For example, signal data with an amplitude higher than the preset threshold in the electrical signal can be removed based on the preset threshold, and an electrical signal with an amplitude lower than the preset threshold is used as base noise data. By calculating the base noise data, the mean value V_{base} and the dispersion σ_{base} of the base noise data can be obtained. The dispersion can be, for example, a standard deviation. The first amplitude threshold can be V_{base}+n*σ_{base}, and the second amplitude threshold can be V_{base}+m*σ_{base}, where n>m, and n and m are positive numbers; and for example, n and m are positive integers. In some embodiments, the first amplitude threshold can be V_{base}+7*σ_{base}, and the second amplitude threshold can be V_{base}+3*σ_{base}. The pulse width threshold is, for example, 1.2 times or above of the echo pulse width in the case of normal incidence.

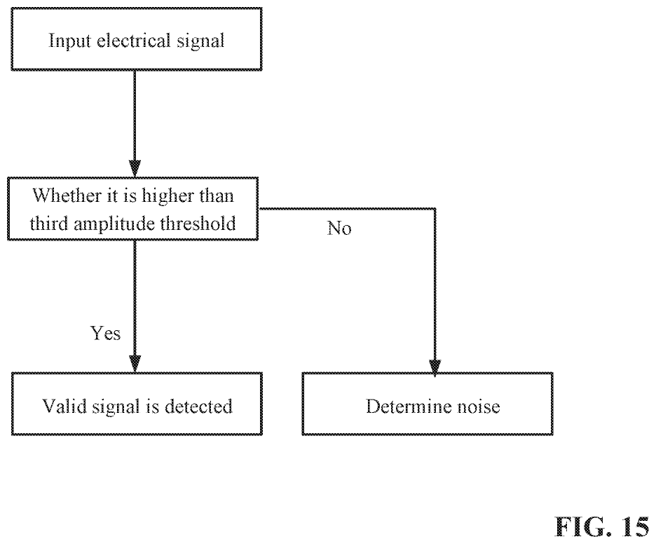

For the electrical signals converted from the echoes formed by the reflection of the detection beams emitted by lasers other than the at least some of the lasers from the object, the processor of the LiDAR may not use a combination of the two amplitude thresholds and the pulse width threshold to determine whether it is a valid signal but determines whether the electrical signal is a valid signal or noise based on a third amplitude threshold. FIG. 15 shows a flowchart of an example method of determining, whether an electrical signal is a valid signal or noise consistent with some embodiments of this disclosure. For example, as shown in FIG. 15, for the electrical signals converted from echoes formed by the reflection of detection beams emitted by lasers 120 other than the at least some of the lasers 120 from an object, the processor 220 can determine whether the electrical signals are valid signals or noise based on a third amplitude threshold. For example, when the electrical signal is higher than the third amplitude threshold, the electrical signal is determined as a valid signal; or otherwise, the electrical signal is determined as noise. The third amplitude threshold can be determined based on the mean value and dispersion of the base noise. The third amplitude threshold can be V_{base}+q*σ_{base}, q is a positive number, and for example, q is a positive integer. The third amplitude threshold can be the same as the first amplitude threshold. For example, in some embodiments, the third amplitude threshold can be V_{base}+7*θ_{base}. Whether this part of electrical signals (e.g., the electrical signals converted from the echoes formed by the reflection of the detection beams emitted by lasers 120 other than the at least some of the lasers 120 from the object) are valid signals is determined through the third amplitude threshold, such that the data processing efficiency of the LiDAR 200 can be improved, and the processing time is shortened.

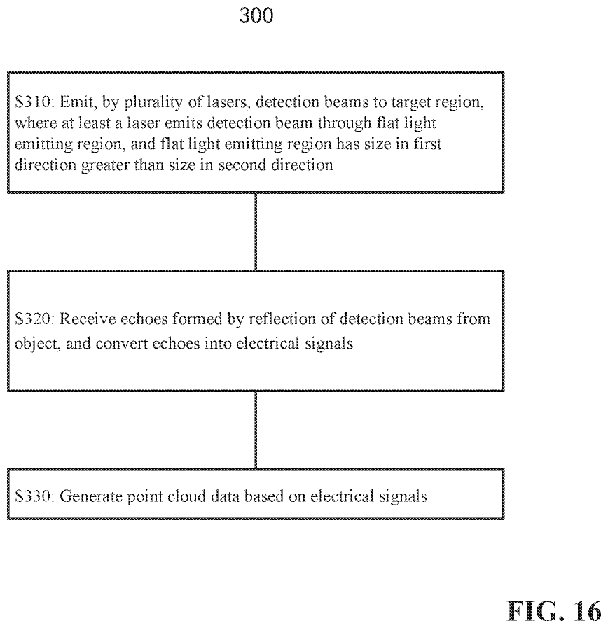

FIG. 16 shows a flowchart of an example method of detection for a LiDAR consistent with some embodiments of this disclosure. A detailed description is made in conjunction with FIG. 16 below.

The method 300 for performing detection by the LiDAR includes the following steps, which are described in detail below.

At step S310, detection beams are emitted to a target region through a plurality of lasers, where at least a laser emits a detection beam through a flat light emitting region. The flat light emitting region has a size in a first direction greater than that in a second direction, where the first direction is a horizontal direction, and the second direction is a vertical direction.

For example, each of the plurality of lasers corresponds to a different field-of-view angle in the vertical direction. At least some of the lasers (e.g., lasers emitting the detection beams through the flat light emitting regions) include all lasers in an emitter, namely, lasers with field-of-view angles corresponding to all field-of-view angles. In other embodiments, at least some of the lasers include lasers with field-of-view angles corresponding to part or all of field-of-view angles below the horizontal direction. For example, the flatness of the light emitting regions of the some of the lasers increases as the field-of-view angles of the lasers approach the horizontal direction, and the flatness of the light emitting regions becomes larger, that is, the ratio of the size of each light emitting region in the horizontal direction to the size in the second direction is larger.

At step 320, echoes formed by the reflection of the detection beams from an object are received, and the echoes are converted into electrical signals.

At step 330, point cloud data is generated based on the electrical signals. For example, corresponding point cloud data can be generated based on valid signals from the electrical signals.

In some embodiments, the method 300 can further include whether at least some of the electrical signals are valid signals or noise is determined based on a first amplitude threshold, a second amplitude threshold, and a pulse width threshold, where the first amplitude threshold is higher than the second amplitude threshold.

The at least some of the electrical signals are converted from the echoes formed by the reflection of the detection beams emitted by the flat light emitting regions of the at least some of the lasers from the object. The pulse width threshold is typically a preset value, and the first amplitude threshold and the second amplitude threshold can be preset values, and can also be calculated by a processor based on the electrical signal.

The step of determining whether the electrical signals are valid signals or noise includes: when the electrical signal is higher than the first amplitude threshold, the electrical signal is determined as a valid signal. When the electrical signal is lower than the first amplitude threshold, and higher than the second amplitude threshold, whether a pulse width of the electrical signal is greater than the pulse width threshold is determined; and when the pulse width of the electrical signal is greater than the pulse width threshold, the electrical signal is determined as a valid signal, or otherwise, the electrical signal is determined as noise.

In some embodiments, the method 300 can further include: a mean value and dispersion of base noise are determined based on electrical signals converted from echoes of the LiDAR. The first amplitude threshold and the second amplitude threshold are determined based on the mean value and dispersion of the base noise.

For example, signal data with an amplitude higher than the preset threshold in the electrical signal can be removed based on the preset threshold, and an electrical signal with an amplitude lower than the preset threshold is used as base noise data. By calculating the base noise data, the mean value V_{base} and the dispersion σ_{base} of the base noise data can be obtained. The dispersion can be, for example, a standard deviation. The first amplitude threshold can be V_{base}+n*σ_{base}, and the second amplitude threshold can be V_{base}+m*σ_{base}, where n>m, and n and m are positive numbers; and preferably, n and m are positive integers. In some embodiments, the first amplitude threshold may be V_{base}+7*σ_{base}, and the second amplitude threshold can be V_{base}+3*θ_{base}.

In some embodiments, the method 300 can further include: for electrical signals converted from echoes formed by the reflection of detection beams emitted by lasers other than the at least some of the lasers from an object, whether the electrical signals are valid signals or noise is determined based on a third amplitude threshold. For example, when the electrical signal is higher than the third amplitude threshold, the electrical signal is determined as a valid signal; or otherwise, the electrical signal is determined as noise.

By configuring at least some of the lasers of the emitter to emit detection beams through the flat light emitting regions, the far-field divergence angle, in the second direction, of the detection beams emitted by these lasers can be reduced, and the longitudinal size of spots formed after oblique incidence of the detection beams emitted by these lasers to the ground is reduced. Thereby it compresses broadening of the electrical signal, increase the peak of the electrical signal and the over-threshold probability of the electrical signal, prevents the valid signals from being omitted, and thus enhances the detection capability of the LiDAR to the ground.

For at least some of the electrical signals (electrical signals converted from echoes formed by the reflection of the detection beams emitted by at least some of the lasers through the flat light emitting regions from the object), by setting a low second amplitude threshold, the over-threshold probability of the noise and the valid signal can be increased. The pulse width of the electrical signal with the peak higher than the second amplitude threshold is detected through the pulse width threshold. The noise can be filtered out, and the valid signal is obtained. The valid signal is not likely to be omitted, and therefore the detection capability of the LiDAR to the ground can be effectively enhanced. Whether other electrical signals are valid signals is determined through the third amplitude threshold, and therefore the processing efficiency of the LiDAR can be improved, and the processing time can be shortened.

It should be noted that as the detection distance increases, by using the flat light emitting regions to emit the detection beams and using a manner of combining the two amplitude thresholds and the pulse width threshold to select valid signals, the detection capability of the LiDAR to the ground can be further enhanced.

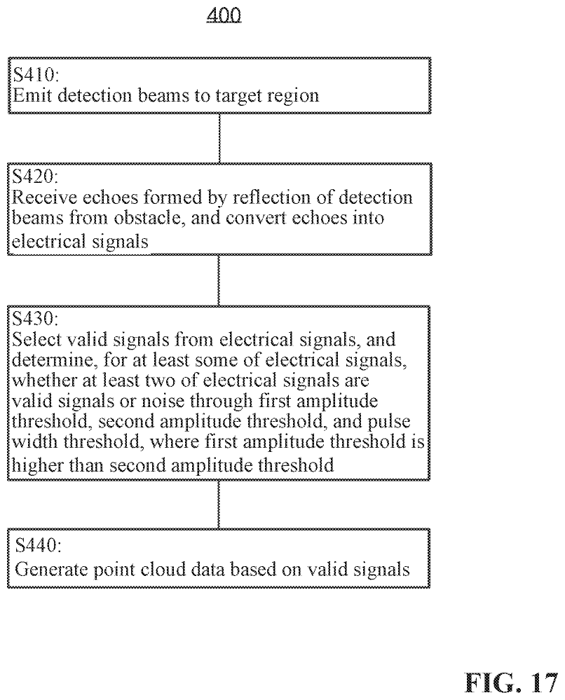

FIG. 17 shows a flowchart of an example method of detecting for a LiDAR consistent with some embodiments of this disclosure. The LiDAR can be a mechanical LiDAR including an optical-mechanical rotor, a scanning semi-solid LiDAR, or a solid-state LiDAR. The LiDAR includes an emitter. The emitter includes one or more lasers and a receiver. The receiver includes one or more detectors. The lasers can emit detection beams. The detectors can receive echoes formed by the reflection of the detection beams from an object. A detailed description is made in conjunction with FIG. 17 below.

The detection method 400 by the LiDAR includes the following steps, which are described in detail below.

At step S410, detection beams are emitted to a target region. In a LiDAR including a laser, a detection beam of the laser can be emitted to the target region through a two-dimensional scanning device and cover a preset field-of-view region. In a LiDAR including a plurality of lasers, the plurality of lasers can emit detection beams to the target region. Each laser can correspond to a different field-of-view angle (e.g., −20° to +20°) in a vertical direction. Then, in conjunction with a one-dimensional scanning device (e.g., a one-dimensional rotating mirror, a galvo scanner, a fast steering mirror, and a motor), the target region is scanned. The plurality of lasers can be arranged into one column, and can also be staggered and arranged into a plurality of columns. For another example, in the solid-state LiDAR, the target region is scanned through the emission of an area array laser and the reception of an area array detector.

At step S420, the echoes formed by the reflection of the detection beams from the object are received, and the echoes are converted into electrical signals. The echoes can be received through the receiver of the LiDAR, and are converted into the corresponding electrical signals. For example, the receiver is provided with the plurality of detectors for receiving the echoes. The plurality of detectors are in one-to-one correspondence with the plurality of lasers to form a plurality of detection channels. The detectors can receive the echoes formed by the reflection of the detection beams emitted by the corresponding lasers from the object.

At step S430, valid signals from the electrical signals are picked out. For at least some of the electrical signals, whether the at least some of the electrical signals are valid signals or noise is determined based on a first amplitude threshold, a second amplitude threshold, and a pulse width threshold, where the first amplitude threshold is higher than the second amplitude threshold. Rather than selecting echo signals with a single preset amplitude threshold, this disclosure provides a solution of using a combination of the two amplitude thresholds and the pulse width threshold to select valid signals from at least some of the electrical signals, so as to reduce or solve the problem that the valid signals are likely to be omitted. For example, for the relatively “short and fat” echo signal shown in FIG. 2, if the echo signal is determined using the determination method with a single preset amplitude threshold, the echo signal is likely to be determined as noise to be filtered out; but by means consistent with some embodiments of this disclosure, considering the factor of the pulse width, such incorrect determination and omissions can be reduced or avoided.

At step S440, point cloud data is generated based on the valid signals.

In some embodiments, by reducing or solving the problem that the valid signals are likely to be omitted, the detection capability of the LiDAR to the ground can be improved.

For example, FIG. 12 shows a flowchart of determining, based on a first amplitude threshold, a second amplitude threshold, and a pulse width threshold, whether an electrical signal is a valid signal or noise consistent with some embodiments of this disclosure. For example, as shown in FIG. 12, after the corresponding electrical signal is obtained, an over-threshold pulse exceeding the second amplitude threshold is picked out, and a pulse that does not exceed the second amplitude threshold can be determined as noise. Whether the peak of the over-threshold pulse exceeds the first amplitude threshold is determined. If the peak of the over-threshold pulse exceeds the first amplitude threshold, the electrical signal is determined as a valid signal and picked out as a valid signal. If the peak of the over-threshold pulse is less than the first amplitude threshold, whether a pulse width of the over-threshold pulse is greater than the pulse width threshold is determined. If the pulse width of the over-threshold pulse is greater than the pulse width threshold, the electrical signal is determined as a valid signal and picked out as a valid signal. If the pulse width of the over-threshold pulse is less than the pulse width threshold, the electrical signal is determined as noise to be filtered out, or alternatively, the electrical signal can be marked as noise.

FIG. 13 shows a schematic diagram of an example electrical signal consistent with some embodiments of this disclosure. For example, as shown in FIG. 13, when the electrical signal is higher than the first amplitude threshold, the electrical signal is determined as a valid signal. When the electrical signal is lower than the first amplitude threshold, and higher than the second amplitude threshold, whether the pulse width of the electrical signal is greater than the pulse width threshold is determined; and if the pulse width of the electrical signal is greater than the pulse width threshold, the electrical signal is determined as a valid signal, or otherwise, the electrical signal is determined as noise. When the electrical signal is lower than the second amplitude threshold, the electrical signal is determined as noise.

The pulse width threshold is typically a preset value, and the first amplitude threshold and the second amplitude threshold can be preset values, and can also be calculated based on the electrical signal. FIG. 14 shows a flowchart of calculating, based on an electrical signal, a first amplitude threshold and a second amplitude threshold consistent with some embodiments of this disclosure. For example, as shown in FIG. 14, base noise data (e.g., baseline noise) can be filtered out based on the electrical signals converted from echoes of the LiDAR, and a mean value and dispersion of the base noise data are calculated. The first amplitude threshold and the second amplitude threshold are determined based on the mean value and dispersion of the base noise. The above steps can be carried out before the LiDAR performs the detection method 400. The first amplitude threshold and the second amplitude threshold are saved in the system and kept stable within a period of time. When environmental conditions (e.g., lighting) change significantly, the above process is repeated.

For example, signal data with an amplitude higher than the preset threshold in the electrical signal can be removed based on the preset threshold, and an electrical signal with an amplitude lower than the preset threshold is used as base noise data. By calculating the base noise data, the mean value V_{base} and the dispersion σ_{base} of the base noise data can be obtained. The dispersion can be, for example, a standard deviation. The first amplitude threshold can be V_{base}+n*σ_{base}, and the second amplitude threshold can be V_{base}+m*σ_{base}, where n>m, and n and m are positive numbers. In some embodiments, n and m are positive integers. In some embodiments, the first amplitude threshold can be V_{base}+7*σ_{base}, and the second amplitude threshold can be V_{base}+3*σ_{base}. The pulse width threshold is, for example, 1.2 times or above of an echo pulse width in the case of normal incidence.

In some embodiments, the at least some of the electrical signals can be electrical signals. In some embodiments, whether the electrical signals are valid signals can all be determined through the first amplitude threshold, the second amplitude threshold, and the pulse width threshold, but this disclosure is not limited to this. In other embodiments, it is possible to determine whether some of the electrical signals are valid signals only through the first amplitude threshold, the second amplitude threshold, and the pulse width threshold. For example, it is possible to determine whether electrical signals generated by the detection channels corresponding to a particular field-of-view range are valid signals only through the first amplitude threshold, the second amplitude threshold.

After a detection beam is obliquely incident to a distant ground, a spot formed by the detection beam is elongated, making an echo short and fat, and the corresponding electrical signal (valid signal) becomes short and fat as well (low peak and large pulse width) while the peak and pulse width of the noise are typically low. By setting a low second amplitude threshold, the over-threshold probability of the noise and the valid signal can be increased. The pulse width of the electrical signal with the peak higher than the second amplitude threshold is detected through the pulse width threshold. The noise and the valid signal can be accurately identified. It makes the valid signal not likely to be omitted and enhances the detection capability of the LiDAR to the ground.

Compared with determining whether an electrical signal is a valid signal through one amplitude threshold, the above determining by the combination of the two amplitude thresholds (the first amplitude threshold and the second amplitude threshold) and the pulse width threshold requires more computational power and/or computation time. Therefore, based on actual requirements, it is possible to only determine whether some of the electrical signals are valid signals through the combination of the above two amplitude thresholds and the pulse width threshold, and whether electrical signals other than this part of electrical signals are valid signals can be determined through the third amplitude threshold.

For example, as shown in FIG. 2, when a detection beam is vertically incident to a distant object, a spot formed by the detection beam is small, an echo is “tall and thin”, and a corresponding electrical signal (valid signal) has a high peak and a small pulse width. When the detection beam is obliquely incident to the distant ground, a spot formed by the detection beam is elongated, an echo is short and fat, and a corresponding electrical signal (valid signal) has a low peak and a large pulse width. Therefore, for electrical signals corresponding to detection beams emitted by lasers with field-of-view angles corresponding to all or some of angles below the horizontal direction, the determination is performed by the combination of the above two amplitude thresholds and the pulse width threshold. The horizontal direction can be understood as the field of view 0° of the LiDAR in the vertical direction. The lasers with the field-of-view angles corresponding to all angles below the horizontal direction can be, for example, lasers with field-of-view angles corresponding to −20° to −1° (in this case, −1° is a negative angle closest to the field of view 0°).

In some embodiments, the at least some of the electrical signals can be electrical signals corresponding to the detection beams emitted by the lasers with the field-of-view angles corresponding to any angle below the horizontal direction, namely, electrical signals converted from echoes formed by the reflection of the detection beams emitted by the lasers with the field-of-view angles corresponding to any angle below the horizontal direction from the object.

FIG. 7 shows a schematic diagram of oblique incidence of two example detection beams to the ground with different incidence angles to form spots and the echoes, consistent with some embodiments of this disclosure. For example, as shown in FIG. 7, the larger the incidence angle that the detection beams are incident to the ground (the oblique downward emission angle of the detection beams is closer to the horizontal direction), the more obvious the broadening of the formed echoes (electrical signals) becomes, and the lower the peak is. Therefore, the combination of the two amplitude thresholds and the pulse width threshold can be used for determining the electrical signals corresponding to the detection beams only emitted by the lasers with the field-of-view angles corresponding to some of angles below the horizontal direction

In some embodiments, the at least some of the electrical signals can be electrical signals corresponding to the detection beams emitted by the lasers with the field-of-view angles corresponding to angles between the horizontal direction and the preset negative angle, namely, electrical signals converted from echoes formed by the reflection of the detection beams emitted by the lasers with the field-of-view angles corresponding to angles between the horizontal direction and the preset negative angle (e.g., −5° to −1°) from the object, and the determination is performed by the combination of the two amplitude thresholds and the pulse width threshold.

FIG. 15 shows a flowchart of an example method of determining, whether an electrical signal is a valid signal or noise consistent with some embodiments of this disclosure. For example, as shown in FIG. 15, whether electrical signals other than the at least some of the electrical signals are valid signals or noise is determined through a third amplitude threshold. For example, when the electrical signal is higher than the third amplitude threshold, the electrical signal is picked out as a valid signal; or otherwise, the electrical signal is determined as noise, and the electrical signal is filtered out as noise; or alternatively, the electrical signal can be marked as noise. The third amplitude threshold can be determined based on a mean value and dispersion of base noise. The third amplitude threshold can be V_{base}+q*σ_{base}, q is a positive number, and for example, q is a positive integer. The third amplitude threshold can be the same as the first amplitude threshold. For example, in some embodiments, the third amplitude threshold can be V_{base}+7*σ_{base}. Whether this part of electrical signals (e.g., electrical signals other than the at least some of the electrical signals) are valid signals is determined through the third amplitude threshold. The data processing efficiency can be improved, and the processing time is shortened.

The above steps for selecting valid signals by using the combination of the two amplitude thresholds and the pulse width threshold for at least some of the electrical signals, thereby reduces or solves the problem that the valid signals are likely to be omitted. In some embodiments, as the detection distance increases, lasers with flat light emitting regions can emit detection beams to compress broadening of corresponding echoes (electrical signals), and increase peaks of the echoes (electrical signals), making the valid signals less likely to be omitted. The following is a detailed description.

Lasers having light emitting regions with different transverse and longitudinal sizes apply to step S410. The following is a detailed description in conjunction with the accompanying drawings.

At step S410, the emitter 100a shown in FIG. 5 can be used for emitting the detection beam. The at least some of the lasers 120 from the plurality of lasers 120 emit detection beams through the flat light emitting regions 121a so as to compress broadening of corresponding echoes, and improve peaks of the echoes. Correspondingly, electrical signals converted from these echoes (echoes corresponding to the at least some of the lasers 120 emitting the detection beams through the flat light emitting regions 121a) have less obvious broadening and high peaks, which are more easily picked out as valid signals at step S430, and are not likely to be omitted.

In some embodiments, for example, as shown in FIG. 5, the flat light emitting region 121a can be rectangular to facilitate the design and manufacture of the laser 120, but this embodiment is not limited to this. In other embodiments, the flat light emitting region 121a can also be of other polygons or ellipses.

In some embodiments, for example, as shown in FIG. 5, the size of the flat light emitting region 121a in the horizontal direction is 2 or more times (e.g., 2-4 times) the size in the vertical direction, so as to reduce the longitudinal far-field divergence angle of the corresponding laser 120, and then reduce the longitudinal size of the spot formed after oblique incidence of the detection beam to the distant ground, making the echoes have less obvious broadening and have higher peaks. For example, the size of the flat light emitting region 121a in the horizontal direction is about 3 times the size in the vertical direction.

In some embodiments, for example, as shown in FIG. 5, the plurality of lasers 120 all can emit a detection beam through a flat light emitting region 121a. Correspondingly, at step S410, the plurality of lasers 120 emit a detection beam through a flat light emitting region 121a. At step S430, whether the electrical signals from the echoes generated by the detection beams emitted by the plurality of lasers 120 through the flat light emitting regions 121a are valid signals or noise can all be determined through the combination of a first amplitude threshold, a second amplitude threshold, and the pulse width threshold; or alternatively, whether some of the electrical signals are valid signals or noise is determined through the combination of a first amplitude threshold, a second amplitude threshold, and the pulse width threshold, and whether some other of the electrical signals are valid signals or noise is determined through a third amplitude threshold.

For example, whether the electrical signals corresponding to the detection beams emitted by the lasers 120 with the field-of-view angles corresponding to angles below the horizontal direction are valid signals is determined through the combination of the two amplitude thresholds and the pulse width threshold; and whether the electrical signals corresponding to the detection beams emitted by the lasers 120 with the field-of-view angles corresponding to angles in the horizontal direction and above are valid signals is determined through the third amplitude threshold. For another example, whether the electrical signals corresponding to the detection beams emitted by the lasers 120 with the field-of-view angles corresponding to angles between the horizontal direction and the preset negative angle are valid signals is determined through the combination of the two amplitude thresholds and the pulse width threshold; and whether the electrical signals corresponding to the detection beams emitted by the lasers 120 with the field-of-view angles corresponding to angles in the horizontal direction and above or below the preset negative angle are valid signals is determined through the third amplitude threshold. Compared with a laser that emits a detection beam through a light emitting region with similar transverse and longitudinal sizes (sizes in the horizontal direction and the vertical direction are substantially the same), the laser that emits a detection beam through a flat light emitting region has a small longitudinal far-field divergence angle, a spot formed after oblique incidence of the detection beam emitted by the laser to the distant ground has a small longitudinal size, resulting in that an echo (electrical signal) has less obvious broadening and a higher peak, which is more easily identified as a valid signal and is not likely to be omitted, thereby improving the detection capability of the LiDAR to the ground. However, the transverse far-field divergence angle of the laser emitting the detection beam through the flat light emitting region is larger, causing a decrease in the transverse point cloud quality contrast of finally generated point clouds, and therefore to improve the detection capability of the LiDAR to the ground and keep the point cloud quality of the point clouds generated by the LiDAR at a high level, only light emitting regions of lasers with the field-of-view angles corresponding to part or all of field-of-view angles below the horizontal direction can be set to be flat. For example, the at least some of the lasers include lasers with the field-of-view angles corresponding to part or all of field-of-view angles below the horizontal direction.

For example, as shown in FIG. 6, the at least some of the lasers 120 may be all lasers 120 with the field-of-view angles corresponding to angles (e.g., −20° to −1°) below the horizontal direction. The lasers 120 with the field-of-view angles corresponding to angles in the horizontal direction and above (e.g., +20° to 0°, including 0°) have light emitting regions 121b with sizes that are substantially the same in the horizontal direction and the vertical direction. Correspondingly, at step S410, all lasers 120 with the field-of-view angles corresponding to angles below the horizontal direction emit detection beams through the flat light emitting regions 121a. The lasers 120 with the field-of-view angles corresponding to angles in the horizontal direction and above emit detection beams through the light emitting regions 121b with sizes that are substantially the same in the horizontal direction and the vertical direction. At step S430, whether the electrical signals corresponding to the detection beams emitted by the plurality of lasers 120 are valid signals can all be determined through the combination of the first amplitude threshold, the second amplitude threshold, and the pulse width threshold; or alternatively, whether some of the electrical signals are valid signals is determined through the combination of the first amplitude threshold, the second amplitude threshold, and the pulse width threshold, and whether some other of the electrical signals are valid signals is determined through the third amplitude threshold. For example, at step S430, whether the electrical signals corresponding to the detection beams emitted by those lasers 120 with the flat light emitting regions 121a are valid signals is determined through the combination of the first amplitude threshold, the second amplitude threshold, and the pulse width threshold. Whether the electrical signals corresponding to the detection beams emitted by those lasers having the light emitting regions 121b with the sizes that are substantially the same in the horizontal direction and the vertical direction are valid signals is determined through the third amplitude threshold. For example, as the field-of-view angle of the laser 120 is larger in approaching the horizontal direction, the flatness of the light emitting region 121a increases. For example, the ratio of the size of the light emitting region 121a in the horizontal direction to the size in the vertical direction is larger.

For example, as shown in FIG. 7, the larger the incidence angle that the detection beams are incident to the ground (the oblique downward emission angle of the detection beams is closer to the horizontal direction), the more obvious the broadening of the formed echoes (electrical signals) becomes, and the lower the peak is. Therefore, the lasers with the field-of-view angles only corresponding to some of angles below the horizontal direction can emit detection beams through the flat light emitting regions 121a.

FIG. 8 shows a schematic diagram of an example emitter based on another example embodiment of this disclosure. For example, as shown in FIG. 8, at least some of the lasers 120 may include all lasers 120 with the field-of-view angles corresponding to angles (e.g., −5° to −1°) between the horizontal direction and the preset negative angle. The lasers 120 with the field-of-view angles corresponding to angles in the horizontal direction and above (e.g., +20° to 0°, including 0°) and below the preset negative angle (e.g., −20° to −5°) have light emitting regions 121b with sizes that are substantially the same in the horizontal direction and the vertical direction. Correspondingly, at step S410, all lasers 120 with the field-of-view angles corresponding to angles between the horizontal direction and the preset negative angle emit detection beams through the flat light emitting regions 121a. The lasers with the field-of-view angles corresponding to angles in the horizontal direction and above or below the preset negative angle emit detection beams through the light emitting regions 121b with the sizes that are substantially the same in the horizontal direction and the vertical direction. At step S430, whether the electrical signals corresponding to the detection beams emitted by those lasers 120 with the flat light emitting regions 121a are valid signals is determined through the combination of the first amplitude threshold, the second amplitude threshold, and the pulse width threshold. Whether the electrical signals corresponding to the detection beams emitted by those lasers having the light emitting regions 121b with the sizes that are substantially the same in the horizontal direction and the vertical direction are valid signals is determined through the third amplitude threshold.

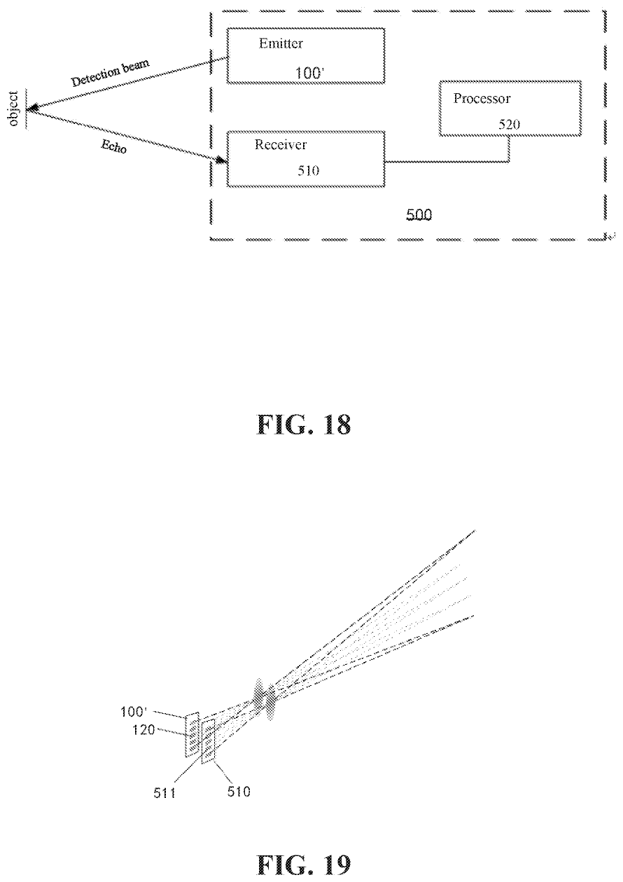

FIG. 18 shows a schematic structural diagram of an example LiDAR consistent with some embodiments of this disclosure. FIG. 19 shows a schematic diagram of an example LiDAR emitting detection beams and receiving echoes consistent with some embodiments of this disclosure. A detailed description is made in conjunction with FIG. 18 and FIG. 19 below.

For example, as shown in FIG. 18, the LiDAR 500 includes an emitter 100′, a receiver 510, and a processor 520. The emitter 100′ can emit detection beams to a target region. The receiver 510 can receive echoes formed by the reflection of the detection beams from an object, and convert the echoes into electrical signals. The processor 520 is coupled to the receiver 510 and can select valid signals from the electrical signals. For at least some of the electrical signals, whether the at least some of the electrical signals are valid signals or noise is determined through a first amplitude threshold, a second amplitude threshold, and a pulse width threshold, where the first amplitude threshold is higher than the second amplitude threshold. The processor 520 can further generate point cloud data based on the valid signals.

In some embodiments, for example, as shown in FIG. 19, the emitter 100′ can include a plurality of lasers 120. The plurality of lasers 120 can be arranged on one or more transmission circuit boards. The laser 120 may be, for example, a vertical-cavity surface-emitting laser 120 (“VCSEL”). The lasers 120 can emit the detection beams. Each laser 120 corresponds to a different field-of-view angle (e.g., −20° to +20°) in the vertical direction. For example, as shown in FIG. 19 schematically showing that the emitter 100′ includes five lasers 120. The five lasers 120 emit detection beams. Echoes formed by the reflection of the detection beams from an object are received by corresponding detectors 211 in the receiver 210. The lasers located at an upper portion of the emitter 100′ emit detection beams below the horizontal direction (e.g., obliquely emitting detection beams downward). The lasers located at a lower portion of the emitter 100′ emit detection beams in the horizontal direction and above (e.g., obliquely emitting detection beams upward). The receiver 510 can include a plurality of detectors 511. The plurality of detectors 511 are in one-to −one correspondence with the plurality of lasers 120. The detectors can receive the echoes formed by the reflection of the detection beams emitted by the corresponding lasers from the object.

In some embodiments, for example, as shown in FIG. 13 and FIG. 18, the processor 520 can select, for at least some of the electrical signals, the electrical signals higher than the first amplitude threshold as valid signals. When the electrical signal is lower than the first amplitude threshold, and higher than the second amplitude threshold, whether the pulse width of the electrical signal is greater than the pulse width threshold is determined; and if the pulse width of the electrical signal is greater than the pulse width threshold, the electrical signal is picked out as a valid signal, or otherwise, the electrical signal is filtered out as noise; or alternatively, the electrical signal can also be marked as noise. When the electrical signal is lower than the second amplitude threshold, the electrical signal is determined as noise.

The pulse width threshold is typically a preset value, and the first amplitude threshold and the second amplitude threshold can be preset values, and can also be calculated based on the electrical signal. For example, as shown in FIG. 14, a mean value and dispersion of base noise (e.g., baseline noise) can be determined based on electrical signals converted from echoes of the LiDAR 500. The first amplitude threshold and the second amplitude threshold are determined based on the mean value and dispersion of the base noise. The above process can be carried out before the LiDAR 500 performs official detection, and the first amplitude threshold and the second amplitude threshold are saved in the system and kept stable within a period of time. When environmental conditions (e.g., lighting) change significantly, the above process is repeated.

For example, signal data with an amplitude higher than the preset threshold in the electrical signal can be removed based on the preset threshold, and an electrical signal with an amplitude lower than the preset threshold is used as base noise data. By calculating the base noise data, the mean value V_{base} and the dispersion σ_{base} of the base noise data can be obtained. The dispersion can be, for example, a standard deviation. The first amplitude threshold can be V_{base}+n*σ_{base}, and the second amplitude threshold can be V_{base}+m*σ_{base}, where n>m, and n and m are positive numbers; and for example, n and m are positive integers. In some embodiments, the first amplitude threshold can be V_{base}+7* σ_{base}, and the second amplitude threshold can be V_{base}+3*σ_{base}.

In some embodiments, the at least some of the electrical signals can be all electrical signals.

In some embodiments, the at least some of the electrical signals can be electrical signals corresponding to the detection beams emitted by the lasers 120 with the field-of-view angles corresponding to all angles below the horizontal direction.

Based on another example embodiment of this disclosure, the at least some of the electrical signals can be electrical signals corresponding to the detection beams emitted by the lasers 120 with the field-of-view angles corresponding to angles between the horizontal direction and the preset negative angle.

In some embodiments, for example, as shown in FIG. 18, the processor 520 can select, for electrical signals other than the at least some of the electrical signals, the electrical signals higher than the third amplitude threshold as valid signals, or otherwise, the electrical signals are filtered out as noise; or alternatively, the electrical signals can also be marked as noise. The third amplitude threshold can be determined based on a mean value and dispersion of base noise. The third amplitude threshold may be V_{base}+q*σ_{base}, q is a positive number, and for example, q is a positive integer.

In some embodiments, for example, as shown in FIG. 5, among the plurality of lasers 120, at least some of the lasers 120 can emit a detection beam through a flat light emitting region 121a. The size of the flat light emitting region 121a in the horizontal direction is greater than the size in the vertical direction. At least some of the lasers 120 from the plurality of lasers 120 emit detection beams through the flat light emitting regions 121a, so as to compress broadening of corresponding echoes, and increase peaks of the echoes. Electrical signals converted from these echoes have less obvious broadening and high peaks, which are more easily picked out as valid signals, and are not likely to be omitted.

In the embodiment of FIG. 5, the plurality of lasers 120 can emit a detection beam through a flat light emitting region 121a. Whether the electrical signals from the echoes generated by the detection beams emitted by the plurality of lasers 120 through the flat light emitting regions 121a are valid signals or noise can be determined through the combination of the first amplitude threshold, the second amplitude threshold, and the pulse width threshold; or alternatively, whether some of the electrical signals are valid signals or noise is determined through the combination of the first amplitude threshold, the second amplitude threshold, and the pulse width threshold, and whether some other of the electrical signals are valid signals or noise is determined through the third amplitude threshold.

In some embodiments, for example, as shown in FIG. 6, the at least some of the lasers 120 can be all lasers 120 with the field-of-view angles corresponding to angles (e.g., −20° to −1°) below the horizontal direction. The lasers 120 with the field-of-view angles corresponding to angles in the horizontal direction and above (e.g., +20° to 0°, including 0°) have light emitting regions 121b with sizes that are substantially the same in the horizontal direction and the vertical direction. For example, all lasers 120 with the field-of-view angles corresponding to angles below the horizontal direction emit detection beams through the flat light emitting regions 121a. The lasers 120 with the field-of-view angles corresponding to angles in the horizontal direction and above emit detection beams through the light emitting regions 121b with sizes that are substantially the same in the horizontal direction and the vertical direction. For example, whether the electrical signals corresponding to the detection beams emitted by those lasers 120 with the flat light emitting regions 121a are valid signals is determined through the combination of the first amplitude threshold, the second amplitude threshold, and the pulse width threshold. Whether the electrical signals corresponding to the detection beams emitted by those lasers having the light emitting regions 121b with the sizes that are substantially the same in the horizontal direction and the vertical direction are valid signals is determined through the third amplitude threshold.

In some embodiments, for example, as shown in FIG. 8, at least some of the lasers 120 can include all lasers 120 with the field-of-view angles corresponding to angles (e.g., −5° to −1°) between the horizontal direction and the preset negative angle. The lasers 120 with the field-of-view angles corresponding to angles in the horizontal direction and above (e.g., +20° to 0°, including 0°) and below the preset negative angle (e.g., −20° to −5°) have light emitting regions 121b with sizes that are substantially the same in the horizontal direction and the vertical direction. For example, all lasers 120 with the field-of-view angles corresponding to angles between the horizontal direction and the preset negative angle emit detection beams through the flat light emitting regions 121a. The lasers with the field-of-view angles corresponding to angles in the horizontal direction and above or below the preset negative angle emit detection beams through the light emitting regions 121b with the sizes that are substantially the same in the horizontal direction and the vertical direction. For example, whether the electrical signals corresponding to the detection beams emitted by those lasers 120 with the flat light emitting regions 121a are valid signals is determined through the combination of the first amplitude threshold, the second amplitude threshold, and the pulse width threshold. Whether the electrical signals corresponding to the detection beams emitted by those lasers having the light emitting regions 121b with the sizes that are substantially the same in the horizontal direction and the vertical direction are valid signals is determined through the third amplitude threshold. In some embodiments, for example, as shown in FIG. 5, the size of the flat light

emitting region 121a in the horizontal direction is 2 or more times the size in the vertical direction, so as to reduce the longitudinal far-field divergence angle of the corresponding laser 120, and then reduce the longitudinal size of the spot formed after oblique incidence of the detection beam to the distant ground, making the echoes have less obvious broadening and have higher peaks. For example, the size of the flat light emitting region 121a in the horizontal direction is about 3 times (e.g., 2-4 times) the size in the vertical direction.

For example, as the field-of-view angle of the laser 120 is larger in approaching the horizontal direction, the flatness of the light emitting region 121a increases. For example, the ratio of the size of the light emitting region 121a in the horizontal direction to the size in the vertical direction is larger.

In some embodiments, for example, as shown in FIG. 9, the laser 120 can include a plurality of light emitting points 122. The light emitting points 122 can be turned on and off. The flat light emitting region 121a is formed by simultaneously turning on some of the light emitting points 122 within the laser 120. Through the above arrangement, the light emitting region of each laser 120 can be dynamically adjusted based on the actual situation. For example, the light emitting regions can have different shapes and sizes (sizes in the horizontal direction and the vertical direction) based on locations of the lasers 120.

Embodiments of this disclosure provide a method 100 for performing a detection by a LiDAR, and a LiDAR 300. Whether at least some of the electrical signals are valid signals is determined through a first amplitude threshold, a second amplitude threshold, and a pulse width threshold. The determination result is more accurate, and identification of the valid signals is improved, making the valid signals not likely to be omitted, and enhancing the detection capability of the LiDAR to the ground. Whether other electrical signals are valid signals is determined through a third amplitude threshold, and therefore the processing efficiency of the LiDAR can be improved, and the processing time can be shortened.

By configuring at least some of the lasers to emit detection beams through the flat light emitting regions 211a, the far-field divergence angle, in the vertical direction, of the detection beams emitted by these lasers can be reduced, such that the longitudinal size of spots formed after oblique incidence of the detection beams emitted by these lasers to the ground is small, echoes (electrical signals and valid signals) have less obvious broadening and higher peaks, and the valid signals are more easily identified and are not likely to be omitted, thereby improving the detection capability of the LiDAR to the ground.

The terms “or” and “and/or” of this disclosure describe an association relationship between associated objects, and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the symbol “/” herein represents that the associated objects before and after the character are in an “or” relationship. In this disclosure, the term “at least one of A or B” has a meaning equivalent to “A or B” as described above. The term “at least one of A, B, or C” has a meaning equivalent to “A, B, or C” as described above.

The terms “a,” “an,” and “the” are intended to represent singular or plural forms, unless expressly stated otherwise in the context. The term “a plurality of” in this disclosure refers to a number of two or more. For example, a plurality of objects can include two objects, or more than two objects. The term “at least one” in this disclosure refers to a number of one or more. For example, at least one object can include one object, or two objects, or ten objects, or the like.

It should be noted that as the detection distance increases, the combination of using the two amplitude thresholds and the pulse width threshold together with the utilization of the flat light emitting regions to emit the detection beams is used for selecting the valid signals, thereby further improving the detection capability of the LiDAR to the ground.

It should be noted that the above description is merely the embodiments of this disclosure but is not intended to limit this disclosure. Although this disclosure is described in detail with reference to the previous embodiments, those skilled in the art can still modify the technical solutions recorded in the above embodiments or perform equivalent replacement on part of technical features. Any modification, equivalent replacement, improvement, or the like made within the spirit and principle of this disclosure should be encompassed within the scope of protection of this disclosure.

1. An emitter of a LiDAR, comprising:
a substrate; and
a plurality of lasers, arranged on the substrate in an array and configured to emit detection beams, wherein a laser of the plurality of lasers is configured to emit a detection beam through a flat light emitting region, and a size of the flat light emitting region in a first direction is greater than a size of the flat light emitting region in a second direction.

2. (canceled)

3. The emitter of claim 1, wherein at least two lasers of the plurality of lasers are configured to emit a first detection beam through a first flat light emitting region, and remaining lasers of the plurality of lasers are configured to emit a second detection beam through a second light emitting region having sizes substantially the same in the first direction and the second direction.

4. The emitter of claim 3, wherein the substrate is divided into a first half region and a second half region along the second direction, the first half region is located in the second half region, and the at least two lasers are located in the first half region or located close to the second half region in the first half region.

5. The emitter of claim 1, wherein the laser comprises a plurality of light emitting points, the light emitting points are configured to be turned on and off, the flat light emitting region is formed by simultaneously turning on at least two of the light emitting points, and the laser comprises a vertical-cavity surface-emitting laser.

6. The emitter of claim 1, wherein the flat light emitting region is oval, rectangular, or polygonal;
the size of the flat light emitting region in the first direction is at least twice as the size of the flat light emitting region in the second direction; and
the plurality of lasers are arranged into one column, or the plurality of lasers are staggered and arranged into a plurality of columns.

7. A LiDAR, comprising:
an emitter, comprising:
a substrate; and
a plurality of lasers, arranged on the substrate in an array and configured to emit detection beams, wherein a laser of the plurality of lasers is configured to emit a detection beam through a flat light emitting region, and a size of the flat light emitting region in a first direction is greater than a size of the flat light emitting region in a second direction;
a receiver comprising detectors, wherein the detectors are configured to receive echoes formed by reflection of detection beams emitted by the plurality of lasers from an object, and convert the echoes into electrical signals; and
a processor coupled to the receiver and configured to generate point cloud data based on the electrical signals.

8. The LiDAR of claim 7, wherein the first direction is a horizontal direction, and the second direction is a vertical direction;
each of the plurality of lasers corresponds to a different field-of-view angle in the vertical direction, and the laser comprises a laser having a field-of-view angle corresponding to an angle below the horizontal direction; and
flatness of the flat light emitting region is configured to increase as field-of-view angles of the plurality of lasers approach the horizontal direction.

9. The LiDAR of claim 8, wherein at least two lasers of the plurality of lasers are configured to emit the detection beam through the flat light emitting region, the at least two lasers comprise all lasers having field-of-view angles corresponding to angles below the horizontal direction or angles between the horizontal direction and a preset negative angle, and lasers of the plurality of lasers having field-of-view angles corresponding to angles in and above the horizontal direction have light emitting regions with sizes substantially the same in the first direction and the second direction.

10. (canceled)

11. The LiDAR of claim 7, wherein the processor is configured to determine, for at least two of the electrical signals, whether the at least two electrical signals are valid signals or noise based on a first amplitude threshold, a second amplitude threshold, and a pulse width threshold, wherein the first amplitude threshold is higher than the second amplitude threshold.

12. The LiDAR of claim 11, wherein the at least two of the electrical signals are converted from echoes formed by the reflection of the detection beams emitted by the laser through the flat light emitting region from an object; and
for particular electrical signals converted from the echoes formed by the reflection of the detection beams emitted by lasers other than the laser from the object, whether the electrical signals are valid signals or noise is determined based on a third amplitude threshold.

13. The LiDAR of claim 11, wherein the processor is further configured to:
determine an electrical signal higher than the first amplitude threshold as a valid signal;
determine whether a pulse width of the electrical signal is greater than a pulse width threshold when the electrical signal is lower than or equal to the first amplitude threshold and higher than the second amplitude threshold;
determine the electrical signal as the valid signal when the pulse width of the electrical signal is greater than the pulse width threshold;
determine the electrical signal as noise when the pulse width of the electrical signal is lower than or equal to the pulse width threshold; and
determine the electrical signal lower than or equal to the second amplitude threshold as the noise.

14. The LiDAR of claim 11, wherein the processor is further configured to:
determine a mean value and dispersion of base noise based on the electrical signals converted from echoes of the LiDAR; and
determine the first amplitude threshold and the second amplitude threshold based on the mean value and dispersion of the base noise.

15-34. (canceled).

35. A LiDAR, comprising:
an emitter configured to emit detection beams to a target region;
a receiver configured to receive echoes formed by reflection of the detection beams from an object and convert the echoes into electrical signals; and
a processor coupled to the receiver and configured to:
select valid signals from the electrical signals,
determine, for at least two of the electrical signals, whether the at least two of the electrical signals are valid signals or noise through a first amplitude threshold, a second amplitude threshold, and a pulse width threshold, wherein the first amplitude threshold is higher than the second amplitude threshold, and
generate point cloud data based on the valid signals.

36. The LiDAR of claim 35, wherein the processor is configured to:
determine an electrical signal higher than the first amplitude threshold as a valid signal;
determine whether a pulse width of the electrical signal is greater than the pulse width threshold when the electrical signal is lower than or equal to the first amplitude threshold and higher than the second amplitude threshold;
determine the electrical signal as the valid signal when the pulse width of the electrical signal is greater than the pulse width threshold;
determine the electrical signal as noise when the pulse width of the electrical signal is lower than or equal to the pulse width threshold; and
determine the electrical signal lower than the second amplitude threshold as the noise.

37. The LiDAR of claim 36, wherein the processor is configured to:
determine a mean value and dispersion of base noise based on the electrical signals converted from echoes of the LiDAR; and
determine the first amplitude threshold and the second amplitude threshold based on the mean value and dispersion of the base noise.

38. The LiDAR of claim 37, wherein the emitter comprises a plurality of lasers, the lasers are configured to emit the detection beams, and each of the plurality of lasers corresponds to a different field-of-view angle in the vertical direction.

39. The LiDAR of claim 38, wherein the at least two of the electrical signals are electrical signals corresponding to detection beams emitted by part or all of lasers having field-of-view angles corresponding to angles below the horizontal direction; or
wherein the at least two of the electrical signals are electrical signals corresponding to detection beams emitted by lasers having the field-of-view angles corresponding to angles between the horizontal direction and a preset negative angle.

40. The LiDAR of claim 36, wherein the processor is configured to:
determine, for particular electrical signals other than the at least two of the electrical signals, a particular electrical signal higher than a third amplitude threshold as a valid signal; or
determine the particular electrical signals as noise when no electrical signal of the particular electrical signals is higher than the third amplitude threshold.

41. The LiDAR of claim 38, wherein at least two of the plurality of lasers are configured to emit a detection beam through a flat light emitting region, and a size of the flat light emitting region in the horizontal direction is greater than a size of the flat light emitting region in the vertical direction.

42-44. (canceled)

45. The LiDAR of claim 41, wherein flatness of the light emitting region of the at least two of the plurality of lasers is configured to increase as field-of-view angles of the plurality of lasers approach the horizontal direction;
a size of the flat light emitting region in the horizontal direction is at least twice as a size in the vertical direction; and
the at least two of the plurality of lasers comprise a plurality of light emitting points, the light emitting points are configured to be turned on and off, and the flat light emitting region is formed by simultaneously turning on at least two of the light emitting points.
